(19) United States
(12) Patent Application Publication
(10) Pub. No.: US 2004/0128262 A1
(43) Pub. Date: Jul. 1, 2004

(54) Distributed processing systems

(76) Inventor: Mahmoud Nafousi, Oxford (GB)

Correspondence Address: STEVENS & SHOWALTER LLP, 7019 CORPORATE WAY, DAYTON, OH, 45459-4238, US

(21) Appl. No.: 10/466,898

(22) PCT Filed: Jan. 25, 2002
(86) PCT No.: PCT/GB02/00326

(30) Foreign Application Priority Data
Jan. 25, 2001 (GB) 0101989.2

(51) Int. Cl. G06F 17/00

(52) U.S. Cl. 705/400

(57) ABSTRACT

A system for selecting one of a plurality of distributed processing entities that each are arranged to process a data set of user-specified criteria to determine a multi-parameter assessment of that data set is described. The system comprises: receiving means arranged to receive the data set via the Internet from an intermediary acting on behalf of the user; an estimation engine for executing a plurality of estimation algorithms, each algorithm being provided by one of the plurality of processing entities and being arranged to generate an approximation of the corresponding multi-parameter assessment by consideration of a processing-entity selected subset of the data set of user-specified criteria; and a selecting module for selecting of one of the processing entities, the selecting means being arranged to consider the generated approximations and select the processing entity whose approximation maximises one or more performance criteria for the intermediary.

### FIELD OF THE INVENTION

The present invention concerns improvements relating to distributed information processing systems and more particularly, though not exclusively systems where determining which one of a distributed plurality of secret processing algorithms is suitable for implementing a process made possible by use of a centralised processing system. The present invention extends to improved messaging techniques where the entropy of messages is increased and to an improved loan management technique.

### BACKGROUND OF THE INVENTION

The present invention and its background is described herein in terms of a business related technique. Whilst a major application of the present invention is in this area, it is to be appreciated that the present invention addresses technical problems which arise as will be explained in detail later. Furthermore, it is possible to apply the present invention to other non-business related areas as will also be explained later.

The retail motor industry sells approximately 2.5 Million new cars per year in the UK alone via a network of franchised car Dealerships. These Dealerships together with a number of used car supermarkets account for a further 2.5 Million used car sales. The annual turnover of the UK retail motor industry is £650 Billion.

Aside from car sales which generate front end profit, a car Dealership also makes back end profits through finance sales. The industry operates on a very tight margin so that often the only profit from a car sale will be the profit from the finance of the deal. Car Dealers sell the finance to the customer at a higher interest (sell rate) than the rate at which they buy from finance companies (buy rate), obtaining the difference as commission from the finance company. Typically, a Dealer makes a commission of around £500 to £600 on each finance deal. In addition to securing finance, the Dealers may also sell extended warranties and insurance bought from third parties and charge documentation fees.

Ideally, a Dealer will sell finance to a customer at the same time as the car sale. In this way, the finance sale is not lost to a competitor or even to a finance company. The amount of commission varies considerably between Lenders; sometimes varying up to £2000 commission per sale.

The likelihood of a finance company (Lender) agreeing to finance a customer and the rates available to that customer depend on the customers credit rating and the Lender's specific underwriting criteria Finance companies consider that there is a lower risk associated with lending money to customers with high credit scores and so will offer financing deals at lower interest rates. The Lenders who finance customers with strong credit records, and in return offer good rates, are termed ‘prime Lenders’, and the customers known as ‘prime customers’. Lenders who finance ‘sub-prime customers’ are known as ‘sub prime Lenders’.

As well as considering the credit scoring of a customer, the underwriting terms may also specify preferences such as the age of the customer and the type of car being purchased, thereby targeting customers within a niche group. These underwriting terms are a finance companies business ‘secrets’ and are guarded jealously. Finance companies have secret algorithms based on these underwriting terms which are used for processing requests for finance (proposals) to determine risk and hence allowability of the proposal. These algorithms are not accessible outside the finance company and for Lenders on the Internet they are only stored at the Lender's web site. Dealers can only get an idea of whether a customer will be accepted or not, and the rates offered by a particular finance company based on previous experience with that Lender. Therefore, it is still possible for a Dealer-expected approval of a proposal based on previous experience of dealing with that Lender, to be rejected when the proposal is actually put to the Lender.

The current procedure for selling finance to a customer at a Dealership involves the Dealer providing a preliminary quote to a customer before any potential Lenders are contacted. This quote must be realistic if a customer is not to be disappointed with a Lenders actual offer but also appealing enough to retain the customers in that Dealership. In giving a quote, the Dealer assesses whether a customer is prime or sub prime based on customer details, intuition and experience. The Dealer provides a quote drawing on previous experience with Lenders and a target profit. In effect, the Dealer must assess the credit score of a customer without doing a credit check and this can often be on the basis of a paper or mental approximate calculation.

For the Dealer to maximise his profits, he needs to be able to predict accurately the rate the Lender will charge. In addition to this, the Dealer must assess the likelihood of that Lender providing finance to that customer. And all this without knowing the full extent of their credit record or the Lender's underwriting criteria. For this reason, Dealers tend to use one or sometimes two Lenders whose rates they have become familiar with. This is severely limiting on competition and the prospect of securing a deal for a non-standard customer is reduced as so many potential Lenders who may have even been able to offer a better deal are excluded.

The customer data is collected manually and forwarded to a finance company or the customer data is collected through a system connected to the manufacturer's finance company or another finance company.

The finance company performs a credit check on the customer and matches the customer data to its own underwriting terms to determine whether they will accept or reject a financing deal with that customer or whether they will refer the customer to their underwriters for further consideration. If the Lender rejects a customer, the customer details are presented to another Lender, with another set of underwriting parameters, until a Lender is found who accepts a deal with that customer.

The disadvantage of such a system to the customer is that every Lender performs a credit check on the customer to provide an accept, reject or refer decision. Multiple access to credit scoring is detrimental to the actual credit score of the customer as refusal of a proposal by one lender will effect the credit rating of the customer for subsequent credit checks, thereby making it increasingly less likely for the customer to obtain a financing deal with every reject decision by the Lenders.

Similarly, it is as important for a Dealer to quickly secure a financing deal with a Lender as with every reject decision, the customer becomes quickly disillusioned with the Dealer and is likely to take his business elsewhere. In addition to predicting the likelihood of a Lender to provide financing to a particular customer, the Dealer must be able to provide a quote which is both appealing to the customer and is predictive of a Lender's rate in order to maximise the profit to the Dealer.

With the present situation, even if the Dealer does eventually find a Lender who is willing to finance that customer they will not have any influence over the levels of commission they will receive, as each Lender pays different amounts of commission.

The system used for Lender/Dealer interactions is a standard Internet model where each of the plurality of Lenders has a secure web site and each of the Dealers has e-mail capability or Internet access to the web sites. In this situation, the Dealer will on behalf of the customer submit a proposal directly to a Lender's web site, the proposal comprising the customer's details, the vehicle details and the required finance details. Whilst this system works well with relatively few Dealers and hence a low-number of requests, as soon as the numbers of Dealers become significant, there is a substantial increase in the amount of Internet traffic which slows down the whole system. Also there is no way of comparing quotations from different Lenders apart from making separate proposals to each Lender with the subsequent re-inputting of customer/vehicle and financing data according the Lender's specific format which gets worse with increasing numbers of proposals being made. This time-consuming and laborious task is enough to put the customer off purchasing the finance from the Dealer.

Accordingly, a technical problem facing the skilled addressee is how to reduce the amount of traffic which is being generated at each Lender's web site. Whilst in some similar situations (for example regarding car insurance) it has been possible to store the suppliers' quotation algorithms on a central database such that comparisons become easier with less traffic to each of the Lender's direct web sites, this is not possible in the present situation due to the high-security issue regarding the Lenders' secret algorithms which no Lender would agree to having stored off their web site. Even though the possibility of the use of encryption techniques exists there is no encryption technique which has been created to date which is not breakable and so the Lenders do not consider this to be a viable solution. The present invention addresses this technical issue and provides a technical solution as is described later.

Finance companies that provide funding loans for hire purchase and personal contract purchase (PCP) agreements also provide stocking loans. Stocking loans provide car Dealers with loans secured by the vehicle stock that the Dealer holds, or enable Dealers to purchase vehicle stock for re-sale to their retail customers. The finance companies use the stocking loan as a means of locking in the Dealer to use them for funding the vehicle finance through them. As the vehicles are used as security for the loan, the vehicles are registered as being owned by the finance company therefore as soon as the vehicle is sold to a retail customer, the Dealer has to pay the finance company. In this regard, the finance company ideally wishes to monitor continuously its security (the vehicles) to check that proceeds of the vehicle sale go to paying off the loan by sending external auditors to check the Dealers internal system and the stock. However, in practice such auditing is periodic and difficult to implement as well as being expensive. Typically, Dealers do use the funds from sales of stocking loan vehicles to help their cashflow situation and as a result, stocking loans are rarely repaid to the Lender on the sale of a stocking loan vehicle as they should. The result of this is the security for the Lender's loan disadvantageously disappears before the loan is repaid generating higher risks for the Lenders.

With any communications system, where there are a plurality of parties sending messages to each other in relation to a multi-stage process involving the parties, it is important to communicate accurately with each of the parties. In particular where several messages can be attached to a single data document it is possible to modify existing systems to know who generated which message and whether the message has been read. However, in order to do this, application software for reading this information about the message is required by each participant and the space taken by this information is never optmised as such systems are general purpose. Different users may have different communications software which raises compatibility and conversion issues in relation to the status information regarding a message. In situations where the messages need to be stored to represent a history of messages between different classes of senders and recipients, for example where deals are being stored between Dealers and Lenders on a communications system, the memory requirement of non-optimised message storage can become a burden.

It is desired to overcome or at least substantially reduce at least some of the above described problems and in particular to address the above described technical problem.

### SUMMARY OF THE PRESENT INVENTION

According to one aspect of the present invention there is provided a system for selecting one of a plurality of distributed processing entities that each are arranged to process a data set of user-specified criteria to determine a multi-parameter assessment of that data set, the system comprising: receiving means arranged to receive the data set via a communications network from an intermediary acting on behalf of the user, an estimation engine for executing a plurality of estimation algorithms, each algorithm being provided by one of the plurality of processing entities and being arranged to generate an approximation of the corresponding multi-parameter assessment by consideration of a processing-entity selected subset of the data set of user-specified criteria; and a selecting module for selecting of one of the processing entities, the selecting means being arranged to consider the generated approximations and select the processing entity whose approximation maximises one or more performance criteria for the intermediary.

This aspect of the present invention provides a solution which appeases the security concerns of the Lenders (distributed processing entities) as they never have to release details or copies of their secret algorithms. The expense and doubts over an alternative solution of encryption of these secret algorithms is not an issue with the present invention. Rather, the Lenders are able to enjoy the benefits of reduced traffic to their sites, and hence faster access for all parties, together with a significantly improved ratio of enquiries to completion of deals.

By selecting a subset of parameters for use with an estimation algorithm, an estimate of the multi-parameter assessment (assessment of a proposal) which is carried out on the full data set is achieved. The estimation algorithm is configured to avoid the need for an external credit check as it is only an estimate, thereby mitigating the problems associated with a worsening credit rating due to multiple rejected credit applications.

The present invention also enables the problems of restricted access to Lenders by Dealers as the automation of the link between them means that a plurality of Lenders can be accessed thereby enabling the best deal to be selected for the intermediary (Dealer). This increased competition also drives down prices and is beneficial for the user (customer).

The technical solution of the present invention is applicable to different non-business related situations. For example, where there are a plurality of distributed image processing centres each with its own secret processing algorithm, previously each image processing centre had to be contacted iteratively and individually by a user seeking to determine the optimal image processing technique for his photographic data. However, using the present invention, the user would only have to submit the characteristics of his photographic image and the desired qualities of the image processing to be carried out to the system via the communications network, which would determine on the basis of the estimation algorithms a selected best image processing centre for processing his image. Each image processing centre would have an estimation algorithm stored at the system which would determine if the required processing was available at the image processing centre and then match the ability to perform the processing to user defined criteria such as processing time, image resolution, image quality etc.

The system may further comprise a proposal engine for generating a proposal to the selected processing entity, the proposal including the data set of user-specified criteria. This advantageously enables the user or entity acting on their behalf which has determined the selected processing entity to complete the process of getting the multi-parameter assessment of the user's data set without the need for commencing an independent process. The user's details need not be entered in again as the data set for the proposal will already have been entered for the execution of the estimation algorithms.

The proposal engine may be arranged to transmit a plurality of different proposals to different processing entities before the proposal engine has received a response from any of the processing entities. In this way multiple proposals can be sent out simultaneously to increase the chances of a positive response in a quicker time frame.

Preferably, the selecting module is arranged to automatically select the processing entity associated with the generated approximation based on one or more pre-stored intermediary-determined performance criteria This is a hugely advantageous departure from the existing practice of manually assessing and comparing quotations back from different Lenders, for example. The automation of this part of the process enables multiple proposals to be sent out iteratively without any need for intermediary interaction thereby saving time and effort.

Another preferable feature of the present invention is that the selecting module may comprise ranking means for ranking the approximations on the basis of the intermediary-determined performance criteria. This again takes the effort of comparing the different multi-parameter assessments to arrive at a preferred processing entity, which effort can become overbearing and time consuming as the number of parameters increases.

Each estimation algorithm may comprise a plurality of sheets of filtration questions for grading the data subset into one of a plurality of categories, each category having associated therewith a set of values for the required approximation to the multi-parameter assessment. This is a relatively quick way of approximating the data subset in order to provide a view as to the likelihood of a successful multi-parameter assessment of a proposal by a processing entity.

In addition, the plurality of filtration sheets may include a data set rejection grading and the selecting module may be arranged to exclude the associated processing entity from possible selection if the estimation algorithm indicates a result of a rejected data subset The advantage of this feature is that the data subset can be used to grade and even filter out bad cases at a relatively early stage and without troubling any processing entities with hopeless proposals.

According to another similar aspect of the present invention there is provided a method of selecting one of a plurality of distributed processing entities that each are arranged to process a data set of user-specified criteria to determine a multi-parameter assessment of that data set, the method comprising: receiving the data set via a communications network from an intermediary acting on behalf of the user; executing a plurality of estimation algorithms, each algorithm being provided by one of the plurality of processing entities and generating an approximation of the corresponding multi-parameter assessment by consideration of a processing-entity selected subset of the data set of user-specified criteria; and selecting of one of the processing entities by considering the generated approximations and selecting the processing entity whose approximation maximises one or more performance criteria for the intermediary.

The present invention also extends to a system for selecting a processing entity for generating a multi-parameter quotation for a user via an intermediary, the system comprising: a plurality of processing entities operably connectable to a communications network, each entity including a secret processing algorithm for considering a set of personal descriptors of the user and generating a multi-parameter quotation based on the set, and a central processing station operably connectable to the intermediary and processing entities via the communications network, the central processing station comprising: means arranged to collect the set of personal descriptors of the user from the intermediary via the communications network; a plurality of estimation algorithms each being provided by one of the plurality of processing entities and being arranged to generate an approximation of the corresponding processing entity quotation by considering a subset of the set of personal descriptors of the user, and means for selecting of one of the processing entities, by consideration of the generated approximations, which maximises one or more performance criteria for the intermediary.

According to another aspect of the present invention, there is provided a method of categorising user-specified data for use in establishing the quality of that data for submission to a processing entity, the method comprising: setting up a plurality of hierarchical sets of questions; iteratively applying the user-specified data to each of the questions in the highest one of the sets until a negative response is received or there are no more question in the set to ask; in response to receiving a negative response, repeating the iteratively applying step to the next set of questions in the hierarchy; re-executing the applying and repeating steps for subsequent responses until either there are no more questions in the set to ask or the lowest level in the hierarchy has been reached; and categorising the user-specified data as the lowest level in the hierarchy encountered by the user-specified data.

This way of categorising user-specified data advantageously enables detailed categorisation of multi-parameter data in such a way that enables it to be used relatively easily for different but specific uses thereafter.

This aspect of the present invention also extends to a system for categorising user-specified data for use in establishing the quality of that data for submission to a processing entity, the system comprising: means for setting up a plurality of hierarchical sets of questions; a processing engine for iteratively applying the user-specified data to each of the questions in the highest one of the sets until a negative response is received or there are no more question in the set to ask; wherein the processing engine is arranged, in response to receiving a negative response, to select the next set of questions in the hierarchy and repeat the iteratively applying process thereto, and is further arranged to re-execute the applying and repeating processes for subsequent responses until either there are no more questions in the set to ask or the lowest level in the hierarchy has been reached; and to categorise the user-specified data as the lowest level in the hierarchy encountered by the user-specified data.

According to another aspect of the present invention there is provided a messaging system for use with a plurality entities connected via a communications network, the system comprising: creating means for creating a message code comprising a plurality of representative alphanumeric characters representing information concerning the status of an attached message, the entity from whom it has originated and identifying the code itself; and incorporation means for incorporating the message code into an electronic message transmittable between the entities.

This aspect of the present invention maximises the entropy of the status information in that only a minimum number of alphanumeric characters are required to represent the sender and status of the message. This mitigates the requirement for any special applications software as all will be able to read alphanumeric characters of the message and hence they can display the status in an understandable format to the reader.

In this situation, preferably the status indicator is comprised of three characters, which is the minimum possible to maximise entropy of the information. The first character would simply be a status identifier, the second to represent the sender and the third to indicate whether the message had been opened.

Use of such a minimal number of characters minimises storage issues and there is no requirement for multiple storage files as the messages can be provided within the text of the message and pulled out for display to the reader when appropriate.

According to another aspect of the present invention, there is provided a system for effecting and administering a stocking loan from a lender to a dealer, the system comprising: a processing station for monitoring the changes to the stocking loan; the processing station being connectable to a communications network linking together the dealer, the lender and an lender appointed auditor of the stocking loan; the processing station being arranged to store details about all the stock of the dealer and the stocking loan such that the outstanding amount of the stocking loan can be automatically updated as the sale of any item against which the loan is secured is recorded by the dealer and wherein the outstanding amount of the loan can be determined by the appointed auditor.

This aspect of the present invention advantageously enables continuous monitoring of the lender's security (the items) as the processing station is used by the dealer like a log of inventory. Accordingly proceeds of the item sales can be checked to ensure they are going into paying off the loan. This can be done advantageously by external auditors simply accessing the system without physically having to visit the each dealer who has a stocking loan.

In addition, the problem of the finance companies use the stocking loan as a means of locking in the dealer to use them for finding the vehicle (item) finance through them is mitigated as the dealer is free to use different lenders who are all accessible via the system.

Preferably the processing station is arranged to carry out independent valuations of the items in order to provide an independent calculation for the purposes of auditor stocking loan evaluation. This independent valuation ensures that there is no disagreement between the auditors and the dealers about the trade values of vehicles for example.

Preferred embodiments of the present invention will now be described by way of example with reference to the accompanying drawings.

### BRIEF DESCRIPTION OF THE DRAWINGS

FIG. 1 is a schematic block diagram of a system embodying the present invention;

FIG. 2 is a schematic block diagram showing the components of the Best Quote Direct (BQD) engine of the system of FIG. 1 in detail;

FIG. 3 is a schematic block diagram showing some of the data stored within the system database of the system of FIG. 1;

FIG. 4 is a flow diagram showing the steps involved in using the system of FIG. 1 to implement a method embodying the present invention of obtaining finance for a vehicle having a plurality of stages;

FIG. 5 is a screen shot of a Lender pricing guideline sheet for use in the method of FIG. 4;

FIG. 6 is a screen shot of a Lender document checklist set up for use in the method of FIG. 4;

FIG. 7 is a screen shot of a table showing a Dealer's business status with Lenders stored within the database of FIG. 3;

FIG. 8 is a screen shot of a Dealer pricing guideline sheet for use in the method of FIG. 4;

FIG. 9 is a screen shot of a table showing a stocking loan arrangement stored within the database of FIG. 3;

FIG. 10 is a table showing parameters for calculating adjusted commission for use with the method of FIG. 4;

FIG. 11 is a screen shot of a CPI pricing sheet for use with the method of FIG. 4;

FIG. 12 is a flow diagram showing the steps involved in step 103 of the method of FIG. 4 of obtaining a quotation for a Dealer to provide to a customer;

FIG. 13 is a flow diagram showing the steps involved in step 109 of the method of FIG. 4 of selecting Lenders and calculating relevant quotations;

FIG. 14 is a screen shot display of a table of Lender-Dealer relationships stored in the system database of FIG. 3;

FIG. 15 is a flow diagram of the steps involved instep 178 of FIG. 13 of the process of filtering out the Lenders that are unlikely to finance a customer and to calculate a price ceiling for the remaining Lenders;

FIG. 16 is a screen shot of a tolerance sheet for use with the scoring step shown in FIG. 15;

FIG. 17 is a screen shot of Lenders selected by step 110 of the method of FIG. 4 ranked in order of highest commission first;

FIG. 18 is a flow diagram of the steps involved in the proposal stage of FIG. 4;

FIG. 19 is a screen shot of a table showing the results of the Lender decision of step 114 of FIG. 4;

FIG. 20 is a screen shot of the particulars of a Lender decision on conditional acceptance obtained at step 114 of FIG. 4;

FIG. 21 is a table showing various message status options in messaging used in the system of FIG. 1;

FIG. 22 is a screen shot showing an e-mail display used in the system of FIG. 1;

FIG. 23 is a schematic diagram showing how a stocking loan arrangement is handled by the system of FIG. 1; and

FIG. 24 is a schematic block diagram showing another embodiment of the present invention with Brokers acting between dealers and the system, and between Lenders and the system.

### DETAILED DESCRIPTION OF THE PREFERRED EMBODIMENT OF THE PRESENT INVENTION

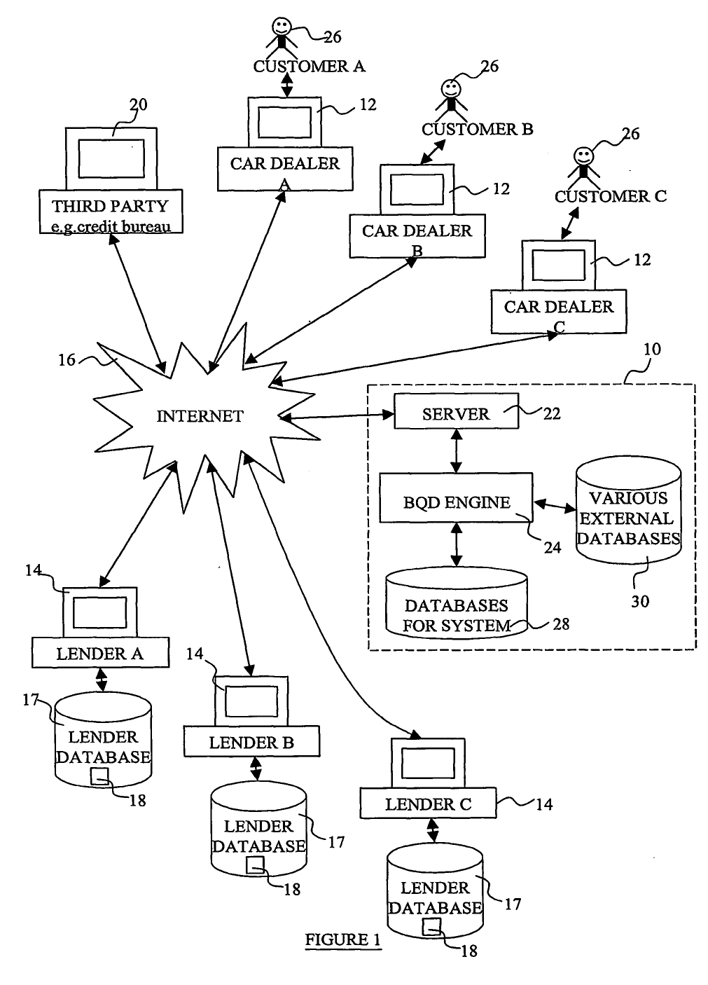

A system for obtaining finance for a customer at a car dealership incorporating a Best Quote Direct (BQD) system 10 according to a first embodiment of the present invention is shown in FIG. 1.

The system 10 is accessed by a plurality of car dealers 12 (Dealers) and finance companies 14 (Lenders) via a wide area network, in this embodiment, the Internet 16. Each Lender 14 has its own database 17 which stores its specific secret finance algorithm 18 which determines a quotation for a loan on the basis of customer and vehicle data. The secret algorithm 18 may require information obtained from a third party such as a credit bureau 20. The system 10 comprises a Web server 22 for hosting a web site where information relating to the financing process can be stored, accessed and updated by the Dealers 12 and Lenders 14. The web site is controlled by a BQD engine 24 which in use carries out the relevant processing of Dealer 12 entered data to assess a customer's credit rating and the likelihood of obtaining finance from particular Lenders 14 as well as calculating the commissions available from Lenders 14 without the Lenders 14 being contacted directly. Having selected one or more Lenders 14 approved by a Dealer 12, the system 10 can send a proposal of a financing deal to a Lender 14 on behalf of a customer 26 at a particular Dealer 12. In order to carry out these functions, the engine 24 has access to a system database 28 for Dealers 12 and Lenders 14. The engine 24 also has access to a suite of external databases 30 such as a voter roll database, a bank sort code database and a car registration lookup database. The Credit Bureau 20 supplying Hire Purchase Insurance (HPI) and NMR (National Mileage Register) data carries information about the prices they charge Dealers 12 or Lenders 14 per transaction. This information is stored in the external suite of databases 30 and is useful, especially in generating the charges payable by these participants to the Credit Bureau 20 for transactions conducted through the system. A database of cars in the UK is stored in the suite of external databases 30.

The way in which the system 10 is used by the Dealers 12 and Lenders 14 is outlined below. The interaction that takes place is mostly through a web browser interface of the web site. The system is accessed by a Dealer 12 to create on behalf of a customer 26, a request for financing relating to a vehicle. The customer details and vehicle details are entered into the system 10 by the Dealer 12 and the system 10 generates a quotation based on predetermined quotation criteria previously input by the Dealer 12. This approximate quotation can then be provided to the customer 26 for consideration. The system 10 then compares the customer data with criteria and prices previously set by the Lenders 14 and provides a likelihood of financing that particular customer 26 as well as the commission available to the Dealers 12 for securing that finance deal. The criteria stored at the system database 28 is a subset of the criteria required for the actual determination of offer of financing and accordingly, any suggestion by the system 10 will always carry a risk of refusal when submitted to the Lender 14 for processing on the secret algorithm 18. This system 10 generated information is made available to the Dealer 12 who can then select a Lender 14 to send a proposal to. Alternatively, the system ranks and selects a Lender 14 based on pre-specified criteria by the Dealer 12 and the system 10 then automatically sends a proposal to the highest ranked Lender 14. When the Lender's system receives the proposal, it processes the information which may include conducting an external credit check with the credit bureau 20 on the customer 26 to either accept, reject or refer a deal with that customer 26. If the customer deal is rejected, the Dealer 12 can repeat the proposal stage with another selected Lender 14 until a deal is accepted or in the case of the automatic proposal, the next Lender in the ranking is automatically sent a proposal. On acceptance of a deal by a Lender 14, this is communicated to the system 10 and subsequently the Dealer 12 can print the required documents, from the web site, and proceed to the next level of deal making with the Lender 14, after getting the signatures from the customer 26. Status monitoring of payment made to the Dealer 12, documents being sent across, formal acceptance by Lender 14 etc are tracked on the system 10. The deal data consisting of the customer data, car data and the quotation data is exchanged between the Lenders, the system and the Dealers primarily by Microsoft Message Queue (MSMQ) or by using an XML or SOAP interface.

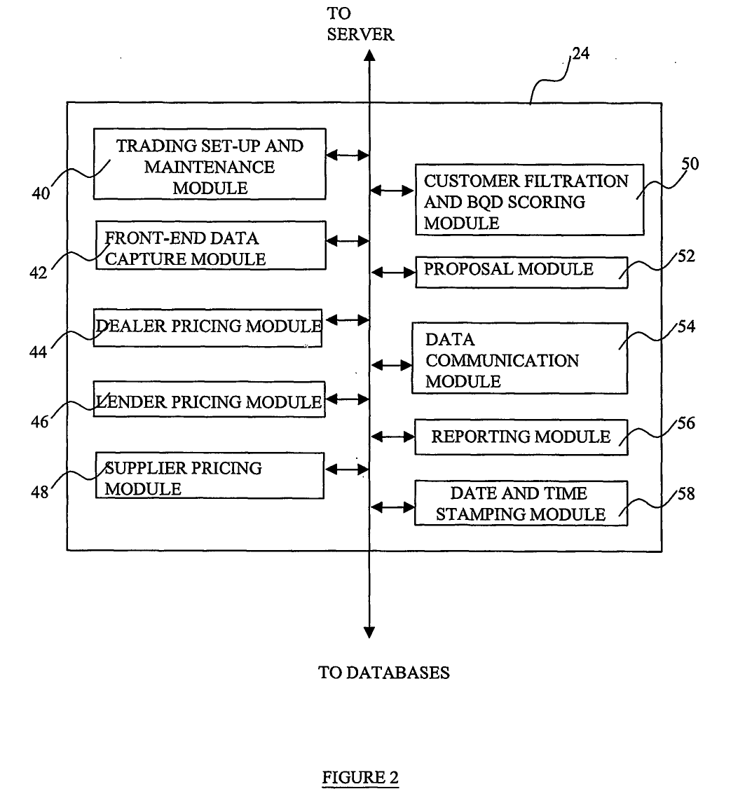

Referring now to FIG. 2, the BQD engine 24 comprises various modules for performing specific tasks which are now described below.

A Trading set-up/maintenance module 40 is provided to enable Dealers 12 and Lenders 14 to interact with the BQD engine 24 for transactions other than those where a customer 26 is involved. This includes a Dealer's application to a Lender 14 for establishing a business relationship, a Dealer's interaction with the BQD engine 24 for setting up his pricing guideline sheet (pricing sheet), a Lender's interaction for setting up his pricing sheets and pricing rules (filtration rules) matrices etc. This module 40 also enables the Dealers 12 and Lenders 14 to set up rules for several other functionalities that are described later.

The maintenance function of this module 40 is used by the BQD engine 24 to carry out data housekeeping. This may include modification of some features, or routine housekeeping of the stored data. Also, the pricing of the charges recoverable by the system 10 from the Lenders 14 and Dealers 12 forms a part of this module 40.

A front-end data capture module 42 helps the Dealer 12 capture all the data related to the customer 26, the car being sold, the financing options chosen by the customer, etc. This module 42 feeds into the modules described below which enables the system to calculate the monthly payments to be made by the customer, the Annual Percentage Rate (APR) etc. Therefore, it is important that the data captured in this module 42 is as comprehensive as possible.

A Dealer pricing module 44 enables a Dealer 12 to quote a rate to the customer 26 by checking the customer details against the Dealer pricing sheet by use of a quotation system (not shown). The rates quoted by the Dealer 12 are based on the age of the vehicle and the credit standing of the customer 26 and so can be generated very quickly with minimial information about the customer having been input Once this quote has been provided to the customer and approved, further information required for a

Lender pricing module 46 can be input Dealers 12 usually quote a rate to the customer 26 that is different to the one that the Lender 14 is charging, in the process earning a commission.

The Lender pricing module 46 allows each Lender 14 to set his own filtration (pricing) rules matrix on the system 10 to enable the Dealer 12 to identify the Lender 14 where he would get the maximum commission. Lenders 14 have a set of pre-defined rules (filtration rules) stored on the system 10, which the system 10 follows for pricing the loan provided to the customer 26. These are rules based on the term of financing, the age of the car (in case of a used car), and so on. These rules taken together with the Dealer's own pricing offered to the customer 26 decide the commission that the Dealer 12 would receive from the Lender 14, if the particular proposal were accepted by the Lender 14 for funding. The Lender pricing module 46 uses a sub set of the variables of the Lender's secret algorithm 18 and the pricing is only an estimate.

A supplier pricing module 48 is provided to allow suppliers of insurance products such as Gap insurance, Warranty, etc. to set up their own pricing and commission levels on the system 10 to enable the system 10 to carry out the necessary calculations, and also to enable the Dealer 12 to charge the customers 26 accordingly.

A customer filtration and BQD scoring module 50 allows each Lender 14 to conduct a credit assessment of the customer 26 itself before checking the customer's credit with the credit bureau 20 by storing a set of filtration rules or routines on the system 10. This module 50 is used to handle the customer filtration logic. The module 50 checks the captured customer details against the filtration rules set up by the Lenders 14 and filters out the Lenders 14 who may not accept the deal for that customer 26. The likelihood of a customer being accepted by a particular Lender 14 is made available to each Dealer 12 at the same time as the commission values associated with that Lender 14. Therefore, this module 50 ensures that only in cases where it appears that the customer 26 is likely to be accepted by a particular Lender 14, is a proposal made by the Dealer 12 to that Lender 14. This is the heart of the system 10, as it determines the Lenders 14 to whom the proposals should be sent Narrowing down the list of Lenders 14 to which a proposal can be sent saves time for both the Dealer 12 and Lenders 14.

A proposal module 52 enables selection of a Lender 14 from the filtered list of possible candidates and assists the Dealer 12 in making the proposal on the Lender's web site. Selection of a Lender 14 can be based on the calculated commission payable by each Lender 14 to the Dealer 12. Subject to certain rules, the Lender 14 with the maximum payable commission is typically placed at the top of the list This module handles the commission calculation logic and may make calls to other mathematical computation modules (not shown). Proposal making is done automatically or manually. That is, either the Dealer 12 can manually choose which Lender 14 to send the proposal to, or he can allow the system 10 to proceed automatically with proposals to Lenders 14 in the order in which they appear in the Lender selection list (which is ordered according to predetermined Dealer criteria).

A data communication module 54 handles all the data communication coming in to or going out of the system 10. Participants (e.g. Dealers 12, Lenders 14, suppliers) will often need to interact with each other through the system 10 and whenever any data needs to be communicated across the system boundary, this module 54 is called. This module 54 facilitates sending of XML (extensible mark-up language) data over MSQM or SOAP, sending of quotation data over e-mail and even sending data by FAX. Communication may be between participants e.g. the Lender 14 communicating his decision after a referral to the Dealer 12. Similarly, the system 10 itself will need to interact with the participants e.g. if a Lender 14 has approved a Dealer's 12 application to be linked to that Lender 14, then the system 10 needs to inform the Dealer 12 that the decision has been taken. The module 54 also incorporates a fully functional mailbox system available automatically to all the participants, but also available to other Dealers/Lenders who can register specifically for the mail and use the fully functional e-mail system. This is the standard web-based e-mail system, with user's e-mail IDs of the nature “username@bqd.com” and need not be described further.

The BQD engine 24 also comprises a reporting module 56 providing extensive reporting features to Dealers 12 and Lenders 14. For instance, a Dealer 12 may want a report indicating the Lenders 14 that he gets the maximum number of rejections from, and the reasons for that. The system operators too may need to keep track of all the deals that are being completed through the system 10 in order to be able to recover this commission from the Lenders 14 for example.

Finally, a time and date stamping module 58 is provided specifically for time stamping each input/output event that occurs with the system 10. This module 58 assists in the accurate functioning of the reporting module 56 as most if not all of the reports generated require time information to be included as a performance measure.

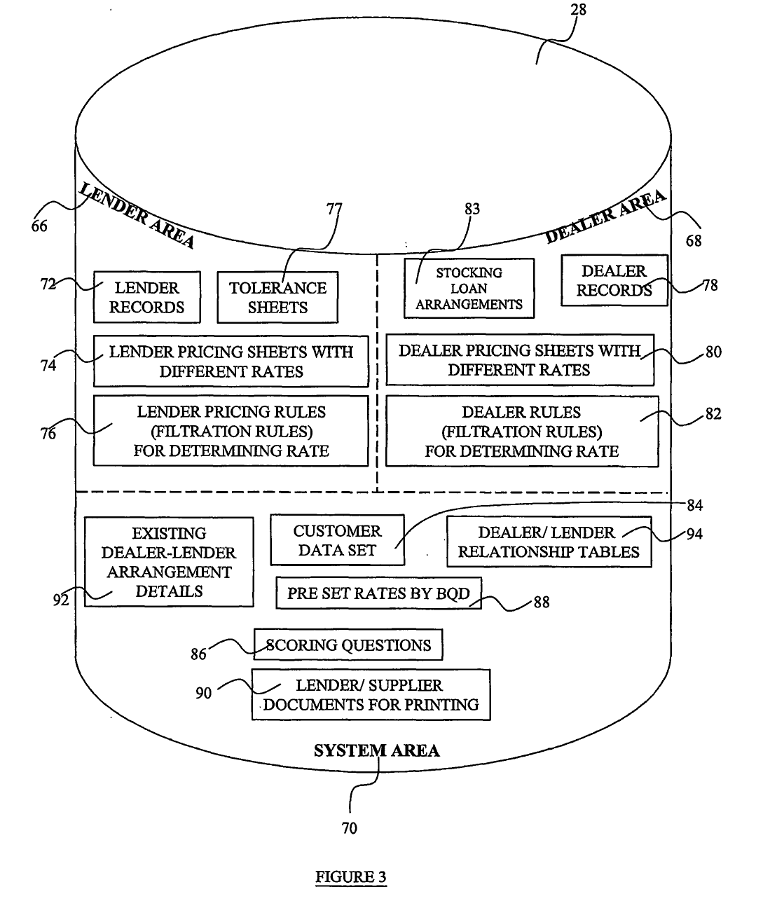

Referring now to FIG. 3, some of the data structures (arrays) stored within the database 28 are now described. The database 28 is divided into three sections, a Lender area 66, a Dealer area 68 and a system area 70. Stored within the Lender area 66 are Lender records 72, Lender pricing sheets 74 with different rates, Lender filtration rules 76 for determining the rate and Lender tolerance sheets 77 for modifying the results of the filtration rules under certain determined conditions. The Lender area 66 can only be accessed by Lenders 14.

The Dealer area 68 contains the Dealer records 78, the Dealer (Guideline) pricing sheets 80, the Dealer filtration rules 82 for determining the financing quotation rates, and stocking loan arrangements 83 (if any).

The system area 70 contains the customer data set 84, scoring questions 86, pre set rates 88 by system personnel, Lender/Supplier documents for printing 90, existing Dealer/Lender arrangement details 92 and Dealer/Lender relationship tables 94.

These data arrays are described in detail later along with the way in which all of these databases interact and are used by the BQD engine in providing a quotation and selecting Lenders is described in detail later.

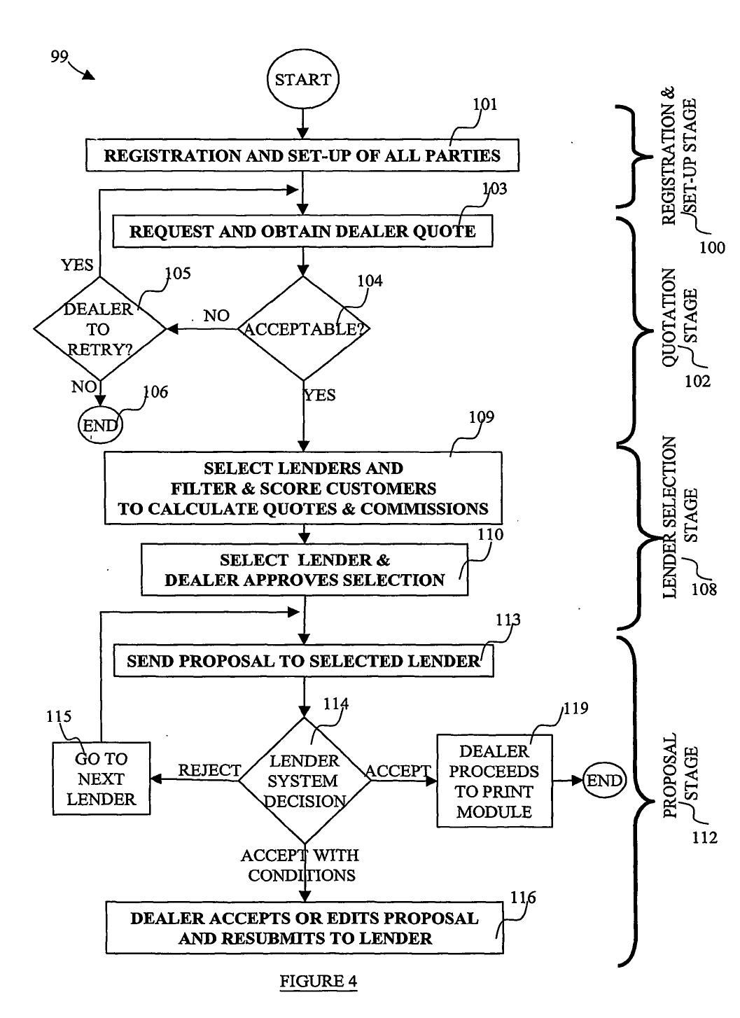

A method 99 of securing finance for a customer 26 with the system 10 is now described with reference to FIG. 4. The method comprises a registration and set-up stage 100, a quotation stage 102, a Lender selection stage 108, and a proposal stage 112.

The method 99 commences at step 101 of the registration and set-up stage 100, with the Dealers 12 and Lenders 14 registering with the system 10. As well as setting up specific user names and passwords, both the Dealers 12 and the Lenders 14 can specify preferred ways of using the system 10, for example, specifying preferred Lenders whose financing options and commission amounts can be requested. Finance prices and commissions under existing arrangements with Lenders can also be entered for comparison with new Lenders. Both Lenders 14 and Dealers 12 set up pricing sheets 74, 80 containing different rates available to customers and filtration rules 76, 82 containing the criteria for applying those rates. This data is used by the system 10 to provide quotations for Dealers 12, calculate commissions and select Lenders 14 based on their likelihood of accepting a financing deal with a customer and the quotation. As mentioned previously, all these preferences and settings are stored in the system database 28.

The method 99 continues with the quotation stage 102 at step 103 when a customer's details are entered into the system 10 at a car dealership by a Dealer 12. The Dealer 12 also captures the customer's choice of car and selection of financing and credit protection insurance options to enable the system 10 to provide a quotation for the customer. The quotation is based on the pricing sheets 80 and filtration rules 82 set by the Dealer 12 at set-up 100. Dealers 12 apply different rates to customers 26 based on the customer credit standing and other factors, to generate a predictive quotation based on the fact that Lenders 14 set higher rates against customers 26 with higher associated risk. At step 104, the Dealer 12 assesses whether the quotation provided by the system 10 to the Dealer 12 is acceptable. If the quotation is not acceptable, the Dealer 12 can decide to retry at step 105 in which case step 103 is repeated after changing some of the input data e.g. the financing options. If the Dealer 12 decides not to retry at step 105, the method ends at step 106.

The preferred way of using the Dealer quotation part 102 of this method 99, is to divide the data input about the deal into two stages. In the first stage, enough information regarding the customer and the vehicle to be purchased is entered to satisfy the Dealer filtration sheets 80 such that a quick quote can be generated. If this quick quote is approved by the customer, then further information is entered in a second stage to meet the requirements of a Lender quote and also a Lender proposal. This way of inputting data enables quotations to be generated at an earlier stage for the customer and the filtering out of hopeless customers is also achieved earlier without having to enter in detailed information about the customer.

If the quotation provided by the system 10 to the Dealer 12 is deemed acceptable by the Dealer 12 at step 104, the method continues with the Lender selection stage 108 at step 109. At step 109, the system 10 identifies the Lenders 14 who are likely to sell financing to the customer 26. Lenders 14 are initially selected from those that have agreed to do business with the Dealer 12 at the registration and set-up stage 100. The system 10 matches the customer details against the pricing sheets 74 and fitration rules 76 set by the selected Lenders 14 to filter out those Lenders 14 who are not likely to finance the customer 26. This step provides a basic assessment of whether or not the customer 26 is suitable for detailed scoring and examination with a particular Lender 14. At the same time as this assessment, the customer 26 is matched to an appropriate Lender pricing sheet 74 which sets a price level ceiling for the quotation. The customers 26 can then be given a more accurate quotation based on the BQD scoring system (described later). The system 10 calculates the commission payable by the Lender 14 by taking the difference between the Dealer's quotation and Lender's quotation.

Dealers 12 view, at step 110, the Lenders' full quotations including commission details and their likelihood of accepting a deal. The system 10 ranks these Lenders 14 according to the highest commission but Dealers 12 can set their own ranking and selection criteria. The Dealer 12 approves a selection made by the system 10 or makes the selection himself and the proposal stage 112 then commences with the system 10 sending at step 113 a proposal to the selected Lender 14.

Once a Lender 14 receives a proposal, it processes the information according to its secret algorithm 18, at step 114. For example, an external credit check with the credit bureau 20 might be performed at this step 114 by the Lender 14. The Lender 14 either accepts the proposal with or without conditions or rejects the proposal. If rejected, the Dealer 12 can repeat the proposal stage 112 by sending a proposal to another Lender 14 at step 115. If the Lender 14 decision at step 114 is to accept the proposal with conditions, the Dealer can, at step 116, accept these conditions or edit the proposal and resubmit it to the same Lender. If the Lender 14 accepts the proposal without any conditions, the Dealer 12 proceeds to the print module at step 119.

Returning now to the registration and set-up stage 100, each party (Lender 14, Dealer 12, supplier etc.) wishing to transact through the system 10 applies online through an application form. The online form captures most of the important information required for records and reference. Besides the Dealers 12 and Lenders 14, various strategic partners supplying for example GAP and MOT insurance may wish to be involved and apply. While the application form must be filled online, the verification and the completion of other formalities with the other parties can be conducted offline. The person completing the application has the option of saving the information entered without submitting it to the system, to enable him to complete the application form later.

Once a party has completed the application form, they are informed by an automatically generated message that they are registered with the system 10. The registered parties are assigned unique usernames and passwords for its users and can now access the set-up area of the web site. Different user names and passwords for different levels of access within each party are provided e.g. at a Dealer company, only one user may have the right to set up the various options, while several other individual users may have the right to make proposals to Lenders.

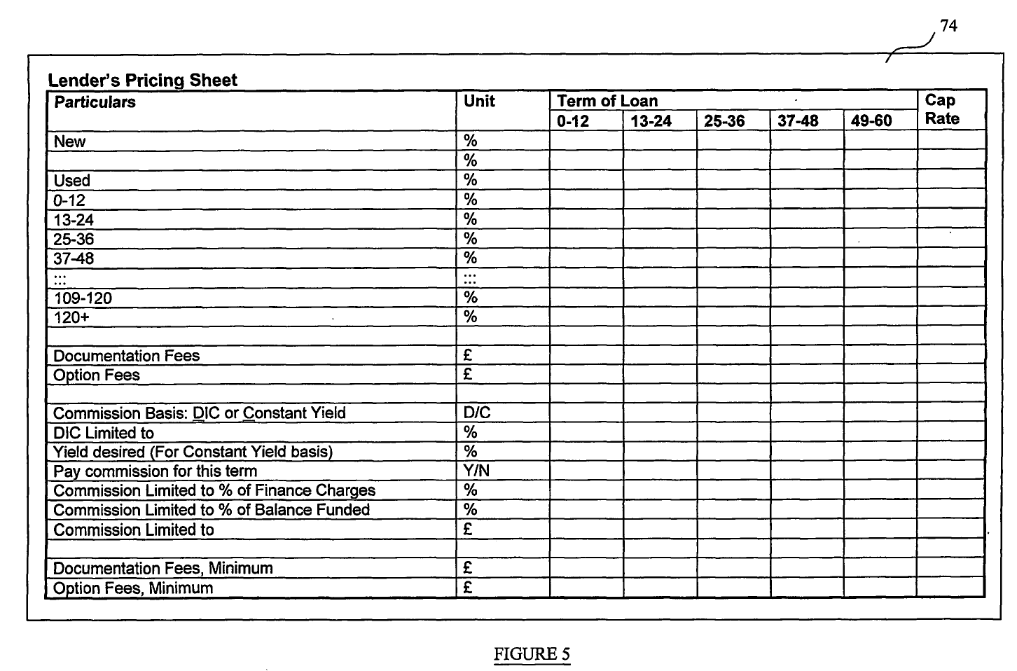

In the registration and set-up stage 100, the authorised Lender 14 sets up his own pricing sheets 74 on the system 10 which are stored in the database 28 and subsequently used by the system 10 to calculate commissions. Each Lender 14 has up to three pricing sheets 74, Platinum, Gold and Silver, for differentiating between customers on the basis of specific circumstances of the proposal and the credit score. The current pricing sheet is displayed as a table of text fields, so that the Lender 14 can change the required fields and save the changes when done. FIG. 5 shows a depiction of the fields to be captured in a Lender's pricing sheet 74. Filtration rules 76, also set up by the Lender 14, determine the pricing sheet 74 that is applicable to a customer 26 and also give an indication as to the likelihood of acceptance of a deal with that customer 26. Tolerance sheets 77 are also specified at this stage to allow adaptation of the scoring questions 86 to meet Lender preferences. The filtration process is discussed in greater detail later with reference to Lender selection.

Each Lender 14 has his own payment process defining conditions such as debit back period (time period where cancellation of loan results in repayment of commission to the Lender) and period after which commission is paid. Most of these conditions are set up by the Lender 14 in the Lender pricing sheet 74. However, the Lender 14 can enter a certain amount of text to be maintained as a static page for viewing by the Dealer 12. The form for this set-up has a text entry field for the Lender 14 to type or paste his text into. On submitting the form, it is stored in the database 28 and is displayed as text whenever the Dealer 12 accesses the partner details area for help.

Lenders 14 can have specific Lender pricing sheets (not shown) for certain Dealers 12 with which they want to have special terms. This sheet identifies the Dealer 12 for whom this sheet applies by a unique Dealer ID number assigned by the system 10. This allows Dealers 12 who have special deals with Lenders 14, or even profit protection arrangements, to include these in the specific Lender pricing sheets. This sheet is identical to the Lender's pricing sheet 74, except that there is an additional field for specifying the profit protection percentage as per the agreement between the Dealer 12 and Lender 14. These specific pricing sheets may be set up by the Lender 14 or by the Dealer 12. When either of them changes the data, the other receives a message from the system asking for confirmation regarding the data change.

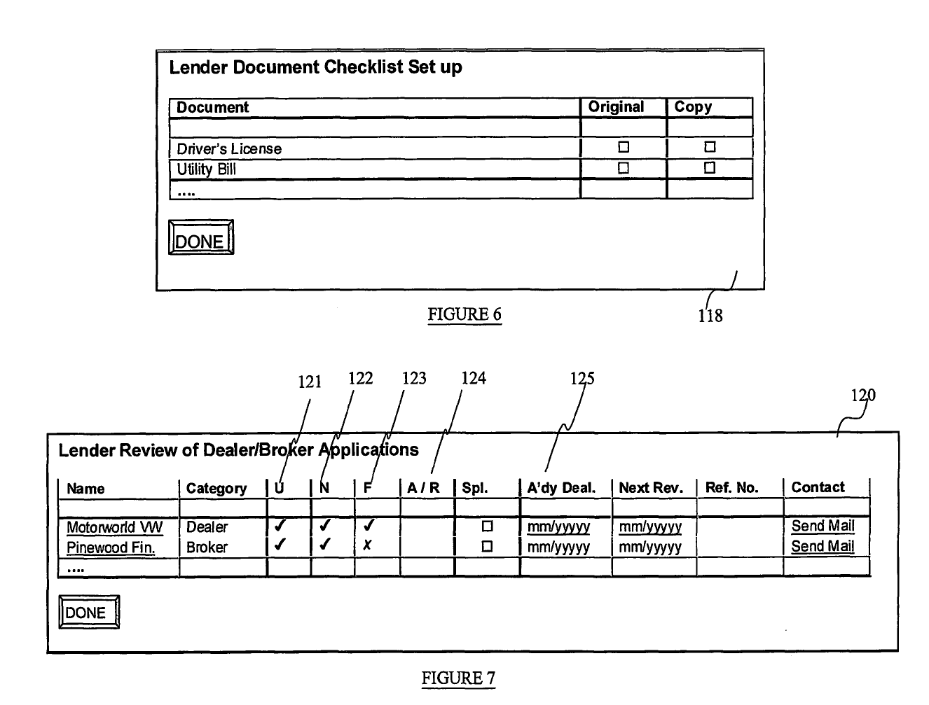

Each Lender 14 requires a specific set of documents from the customer 26 for completing a deal. The system 10 has a comprehensive list of documents that may be required and the Lender 14 specifies the documents required by him. This list is maintained as a static table for viewing by the Dealer before making the proposal. The document check-list set-up table 118 is shown in FIG. 6.

In the Dealer 12 part of the registration and set-up stage 100, the Dealer 12 specifies the Lenders 14 with whom he has existing relationships and those with whom he wishes to transact despite not having an existing relationship with them, in a table 120 shown in FIG. 7. The table 120 is then placed in a Lender area of the web site, in the form of an application (from the Dealer 12 to transact with the Lender 14) awaiting acceptance from the Lender 14. The U/N/F fields 121, 122, 123 in the table 120 indicate whether the Dealer 12 deals in used cars, new cars or whether the Dealer is a franchised Dealer. The Lender 14 inputs his decision (accept/reject) into the table 120 and this is shown in the AIR field 124. The ‘A'dy Deal.’ (already dealing) field 125 is filled in if the Lender 14 has an established relationship with the Dealer 12 and the Dealer 12 was not one introduced through the system 10. The Dealer 12 cannot conduct business with the Lender 14 until the AIR field 124 is selected.

Once the Dealer 12 has been registered and accepted as a partner by at least one of the Lenders 14, the designated personnel of the Dealer 12 can set up the Dealer pricing sheet 80, the Dealer filtration rules 82, the specific Lender pricing sheet (not shown) and details of stocking loan arrangements 83 with Lenders (if any).

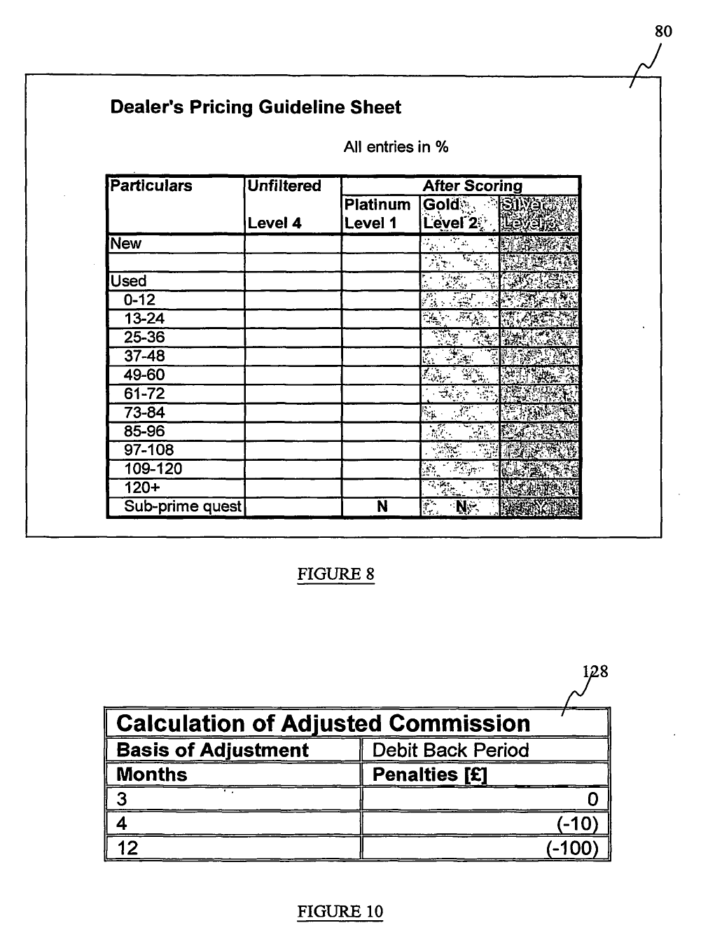

The Dealer pricing sheet 80 allows the system 10 to provide a guideline quotation for the Dealer's personnel to give to the customer 26. The format of a Dealer pricing sheet 80 is shown in FIG. 8 and although not shown, in practice the Dealer would populate the sheet 80 with quotations covering all the possible category combinations. The Dealer pricing sheet 80 is less complicated than the Lender pricing sheet 74, since the quotation given is based on a pre-selected rate and depends only on the age of the car and the credit standing of the customer 26, and not on the term of the agreement

A Dealer 12 has several levels of rates which depend on the credit standing of the customer 26 or even on whether the customer 26 is asking only for a quotation (unfiltered), or is wiling to share his personal information. This helps the Dealer 12 to set the rate according to the expected price to be charged by the Lenders 14, since the Lenders 14 are likely to charge a higher rate for sub-prime customers. Filtration rules 82 regarding which set of rates to be used for quoting to a particular customer are also set at this time by the Dealer 12. The system 10 also has recommended rates that Dealers 12 can choose to use as a starting point while doing their set-up. The Dealer 12 can also set the parameter for whether or not an indicative rate is to be displayed before scoring. The set-up for scoring is performed by the system 10, and Dealers 12 are provided with the option of using it

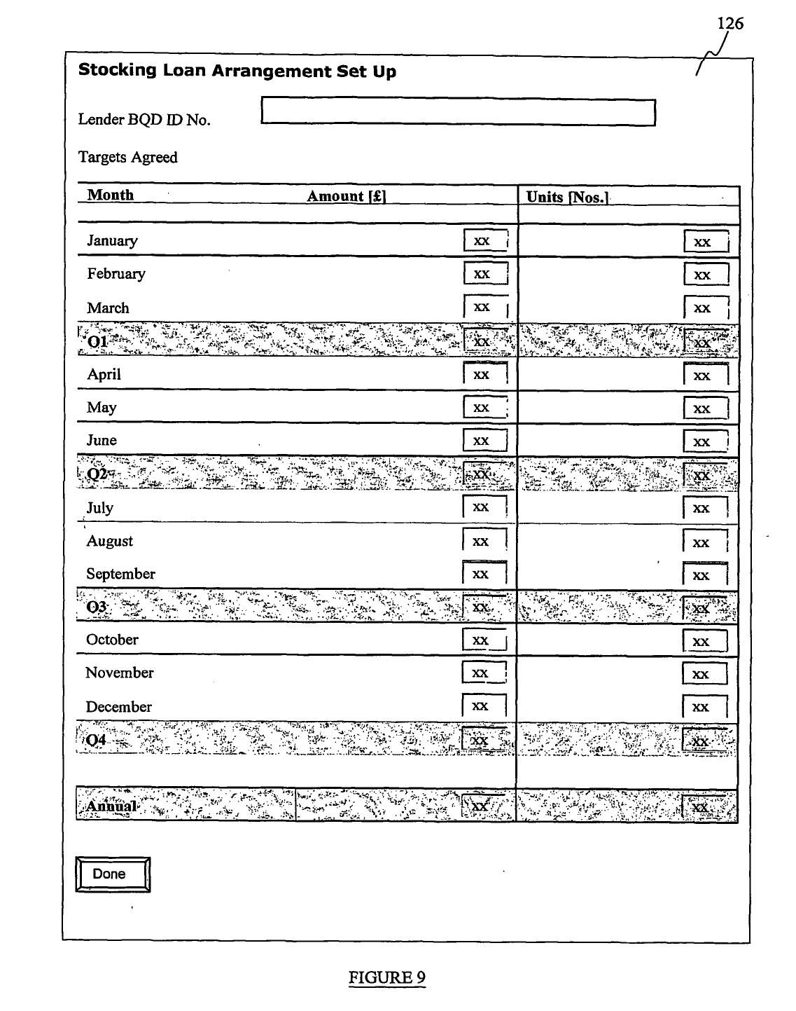

Dealers 12 enter the details of any stocking loan arrangements 83 they have with Lenders. The set-up form 126 appears as shown in FIG. 9. Various terms and conditions are specified by the Dealer 12 in this form 126. The Dealer 12 fills in either monthly, quarterly, or annual figures. If the Dealer 12 has filled in the monthly figures, then the quarterly and annual figures will be filled in automatically. Similarly, if quarterly figures are entered, the annual figure will be calculated automatically. If Dealers 12 are conducting business with the Lender 14 without use of the system 10, the Dealers 12 have an additional form to input the year to date (YTD) figures against the stocking loan 83 and overwrite the system calculated figures.

The Dealer 12 can specify whether the Lenders 14 to be selected for making the proposal should be selected on the basis of commission, or whether the debit back period or other factors such as payment period should be taken into account. For this purpose, the concept of adjusted commission is introduced. Adjusted commission is the resultant commission obtained from the commission payable by the Lender 14, after penalising him for the Lender-specified debit back period, as set by the Dealer 12. For instance, the Dealer 12 could set up the penalties as shown in the table 128 in FIG. 10. The penalty figure entered is subtracted from the commission payable by the Lender and in this case an increasing debit back period results in an increasing penalty.

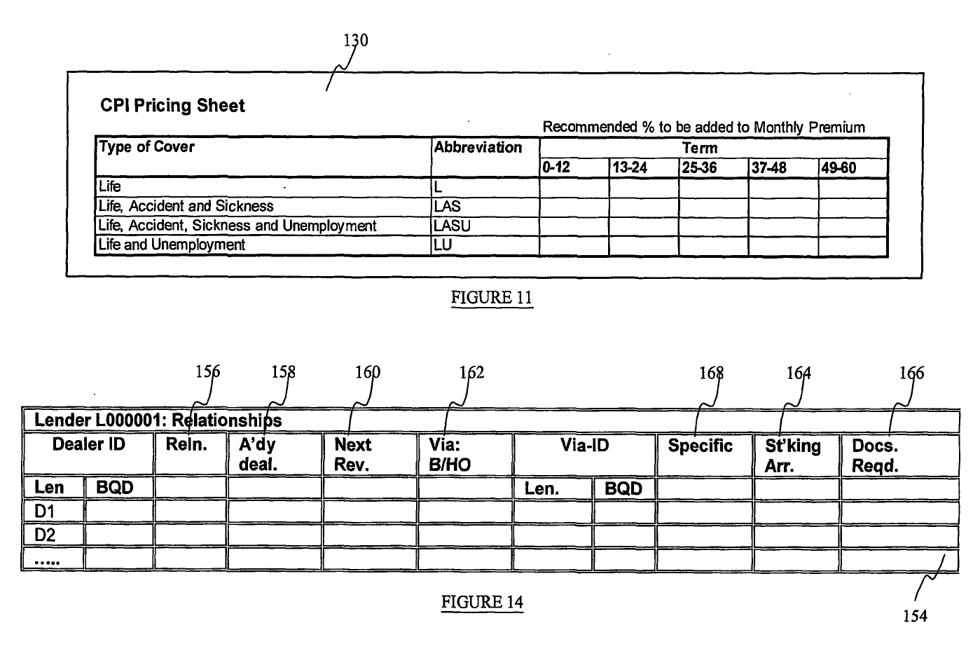

Dealers 12 and Lenders 14 also have the option of setting up their own pricing sheets for credit protection insurance (CPI) 130, an example of which is shown in FIG. 11. These prices and the commission terms are used by the system 10 to calculate the monthly payment for the customer 26 and the commission payable to the Dealer 12. Dealers 12 can choose to use recommended rates pre-set by the system 10 as a starting point while doing their set-up. Dealers 12 can also specify a maximum discount percentage that their personnel can offer to the customer 26.

The strategic partners supplying Gap insurance, MOT insurance, pricing of car, warranty and other insurance commission also have pricing sheets stored on the system 10 which are used by the system 10 to capture the premium for the quotation system as well as to calculate the commission payable to the Dealer 12. The Dealer commission is the balancing figure so that if the Dealer 12 sells the insurance below recommended retail price (RRP), then the difference is adjusted against the commission payable to him.

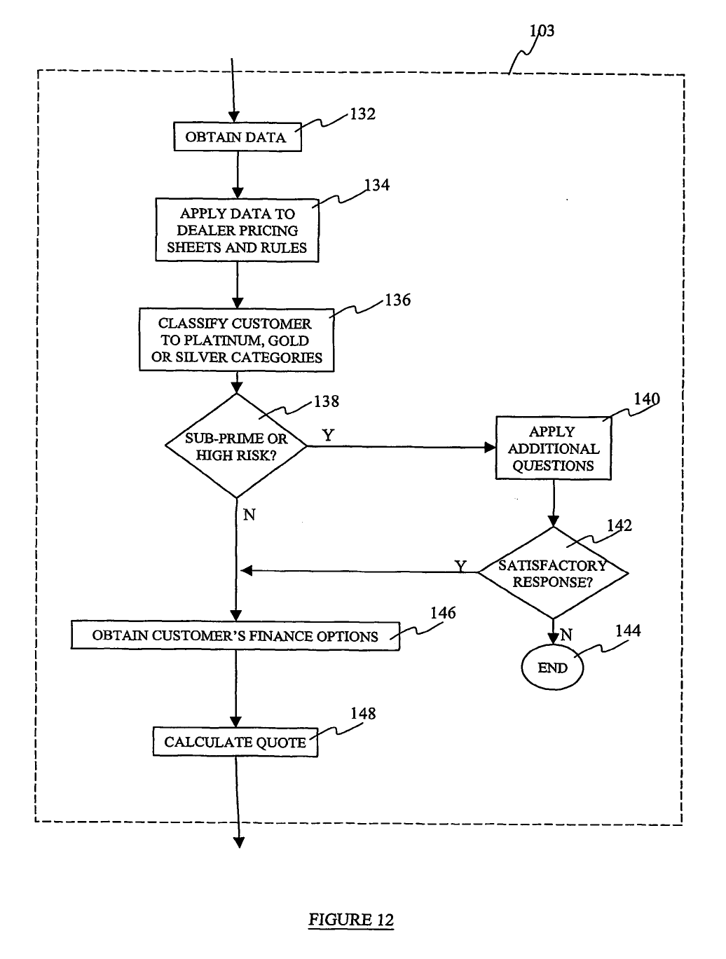

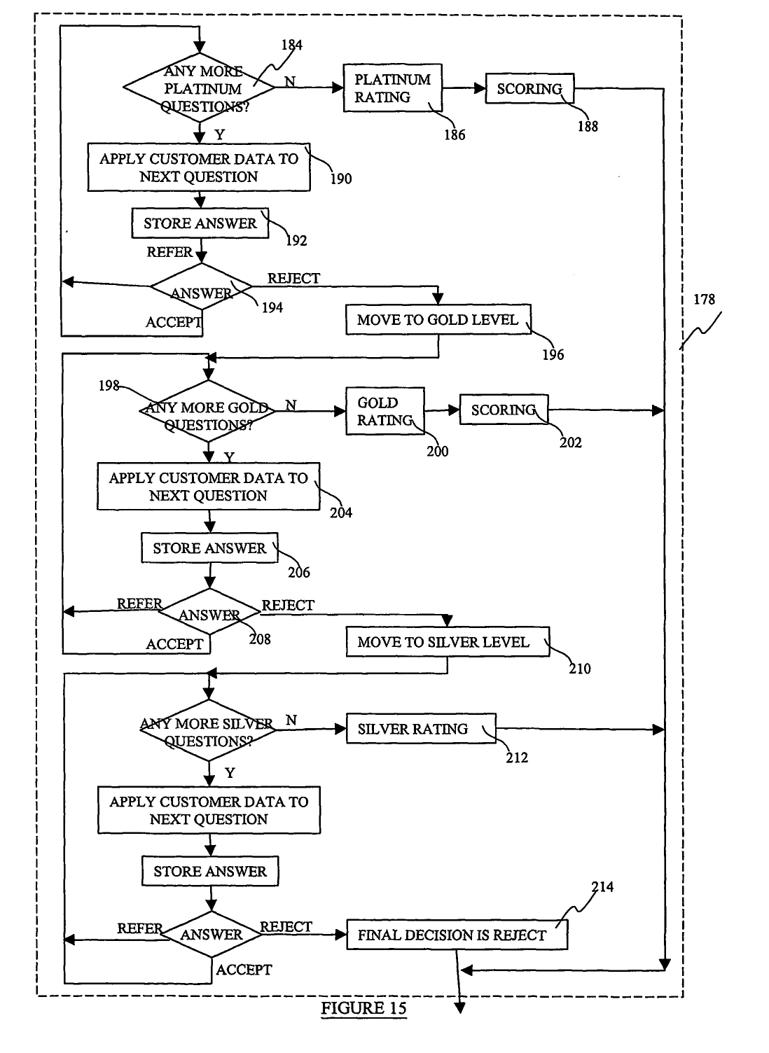

Referring now to FIG. 12, the step 103 of requesting and obtaining a Dealer quotation shown in FIG. 4 is described here in more detail. Step 103 commences with the customer details and details regarding the customer's selection of car being entered, at step 132, into the system 10 by the Dealer 12. Based on the customer's credit standing and the age of the vehicle, the system 10 applies, at step 134, the Dealer set filtration rules 82 to filter the customer 26 to a Dealer guideline pricing sheet (Platinum, Gold, Silver) 80, at step 136. The purpose of filtration is to identify the customers not likely to be financed by prime Lenders (e.g. sub-prime customers) and to group the customers likely to be financed according to the desirability and risk of supplying finance to them. This filtration step also takes place at the Lender selection stage 108 and is described in more detail with reference to Lender selection and FIG. 15. If as a result of the grouping/filtering step the customer is classified at step 138 under a high risk category (sub-prime), then additional questions are asked at step 140 in order to determine if any Lenders who deal with such sub-prime customers would still be able to provide a quote for them. If the additional questions result in a satisfactory response determined at step 142 then the procedure continues as though the customer was classified as a prime customer. Otherwise, the procedure ends at step 144 because the Dealer filtration rules 82 (based on Dealer experience) have determined that this customer will not be able to attain finance. Coming to such a conclusion advantageously reduces the number of hopeless cases being processed by the rest of the system thereby reducing traffic to Lenders.

Assuming the customer is a prime customer or acceptable sub-prime, the process continues with the customer selecting at step 146 their preferred finance options. Subsequently, a quotation is provided at step 148 to the customers once they select their finance options. The quotation is provided by matching the captured details with a Dealer pricing sheet 80.

The filtration rules 82 for identifying the pricing sheet 80 to be applied to a customer are set by the Dealer 12 based on predictions of a Lender's likelihood to accept a deal with a customer 26 and the risk they might associate with that deal. The information entered at the quotation stage 102 is used by the Lender 14 for purposes of credit scoring at the Lender selection stage 108. This is due to the fact that for a given profile of customer 26, the Lender 14 may be willing to lend up to a certain amount or for a certain set of cars, but not beyond that Or the Lender 14 may just decide that the higher the amount of funding required, for example, the higher the risk, the higher the credit score (rating) should be. In order to enable such decisions, all this information is available to the filtration and scoring functionality 50 of the BQD engine 24.

As mentioned above, there is a set of questions that the customer 26 answers, at step 140, if the system 10 indicates that none of the prime Lenders are likely to accept the deal and that the sub-prime Lenders must be approached. These additional questions deal mainly with customer income levels, existence of county court judgements (CCJs), and so on. These questions must also be asked if the Dealer 12 feels it is required in the case of a high-risk customer, or if the Dealer pricing filter returns a commission determining price level for the customer below the threshold level set up by the Dealer 12. The Dealer can choose to turn these questions on or off at any time.

In providing a quotation to the Dealer at step 148, the system 10 mainly accesses the customer data, the Dealer pricing sheets 80 and the filtration rules 82 set up by the Dealer 12. The Lender pricing sheet 74 is accessed for the documentation and transfer fees that the Lender 14 will charge the customer 26. The documentation fee is to be paid by the customer 26 along with the first monthly installment for this financing. The transfer fee is the fee that the Lender 14 will be charging the customer 26 at the end of the agreement to transfer the car to the customer's name and is to be paid by the customer 26 with the last monthly installment These values can be changed by the Dealer 12 and the commissions adjusted accordingly. The maximum acceptable values that Lenders 14 can set up for the documentation and transfer fees are determined by the system 10.

Whilst not shown in FIG. 12, there are several other functions available to the Dealer 12 which are described below. For example, the Dealer 12 can also conduct a hire purchase investigation (HPI) at the quotation stage 102. Each car sold on finance must be registered with the credit bureau 20 by the Lender 14. Therefore, when a used car is being bought, the buyer can confirm with the credit bureau 20 whether that particular car is free or is still under hire purchase by a Lender 14. This is especially important when accepting a car as part exchange for a new car. HPI is carried out by the system 10 sending the vehicle registration number to the credit bureau 20 via the Internet 16 for checking the existence of any hire purchase interest on the car. The credit bureau 20 returns information about the existence of the interest, and the details of the interested patty. On the system, the HPI text entry field accepts the vehicle registration number from the Dealer 12, and on clicking on the HPI text (or button), the communications link is established with the credit bureau 20, and information is exchanged.

At the quotation stage 102, the Dealer 12 can also select insurance e.g. GAP, MOT, warranty, from third party Suppliers. The Dealer 12 can print the Supplier's marketing documents stored in the database 28 or the system 10. For Gap insurance, for example, the system 10 picks up the Gap premium from the Gap pricing sheet and calculates the commission accordingly. This value of premium is entered in the Gap field on the main quotation page. If the Dealer 12 overwrites that value, the new value is used to calculate the commission. However, if the Gap insurance is being sold on cash, no value is entered into the field in the main quotation system.

The Dealer 12 can choose the type of Gap insurance policy being sold to the customer 26 with regards to the coverage (total loss or finance), payment (cash, with loan, or separate funding), and the finance period (one to five years or with loan).

Finance Gap insurance has to be a part of the vehicle finance agreement and hence it is possible only if the vehicle is being sold on credit. However, total Gap insurance can be sold even in cases where the car is being sold for cash. In that case, the Gap insurance can be sold either for cash or by off-pad financing. The duration of finance Gap insurance can only be equal to the duration of the car loan. For total loss Gap insurance, the duration may be different.

The Gap insurance selling form depends upon whether it is invoked from the proposal or directly from the main screen. In case it is invoked from the proposal, then the customer and car details that have been captured are filled in the Gap insurance forms, otherwise the Dealer 12 enters the details. Here too it is possible for the Dealer 12 to sell Gap insurance after the agreement documents have been printed and signed The deal details are updated in the system 10 accordingly.

If the car is sold on cash, the Dealer 12 still has the option of selling Gap insurance to the customer 26, either on cash or on off-pad credit i.e. separate finding. In case the Dealer 12 specifies that Gap insurance is to be sold on cash, the form captures only the customer's name and address, and other information related to the car such as the registration number, mileage, invoice number and date, delivery date, etc. If the Gap insurance is being sold on separate funding, the complete customer details form is reproduced, since a credit check may be required, and vehicle details are also captured.

Barring car insurance, all insurance payments are added to the monthly interest (MI). Car insurance cannot be finded along with the loan and hence is not added to the MI. Warranty is VAT-able and hence added to the invoice price of the car, although it is shown as a separate item on the invoice.

Credit protection insurance (CPI) can be handled in two ways:

1. MI on car loan is calculated and CPI is added on as a percentage of that.

2. CPI is added on as a percentage of balance funded and then MI is calculated.

Method 1 above is used for display on the main quotation screen. However, the Lender 14 specifies his chosen method in the CPI pricing sheet 130. At the time of printing the documents for signing, the appropriate method is used and the appropriate MI and APR entered into the respective fields on the print documents.

For insurance payments, the Lender 14 specifies in the pricing sheet 74 whether or not he will fund the payment of insurance. In case a Lender 14 does not finance the insurance, the Lender selection list displays the commission for that Lender 14 as being the value equal to the actual commission from that Lender 14 plus the commission from the off-pad funder. There will be only one off-pad finder on the system, as a Strategic partner.

The Dealer 12 has the facility of providing the customer 26 with a legally acceptable written quotation. The system administrators and the Dealer 12 have the facility of changing the exact text that goes into the quotation.

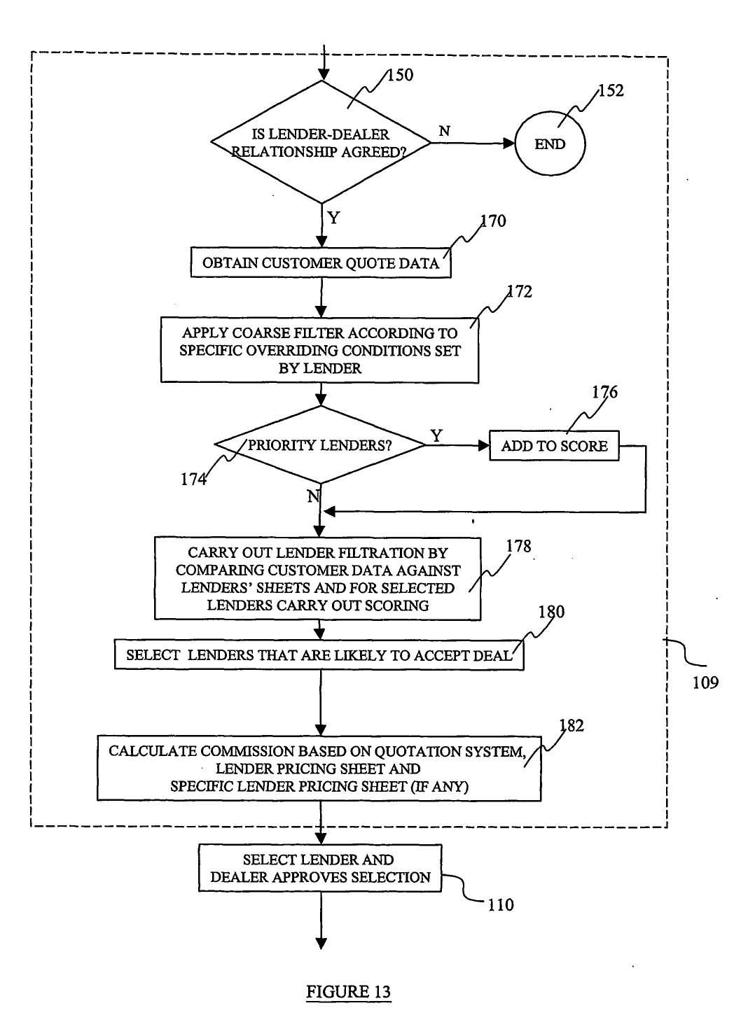

Referring to FIG. 13, the process of Lender selection at step 109 in FIG. 4 by the system 10 is now discussed in detail. The most fundamental functionality of the system is to assist Dealers 12 to select Lenders 14 for each deal so that the best deal is obtained and as a result the commission earned by them is maximised. This selection follows a certain logic and a set of rules to ensure that any special conditions that may have been set up by any of the Dealers 12 or Lenders 14 are taken into consideration. The logic is defined beforehand by the system 10 and the Dealers 12 and Lenders 14 do not have the authority to change them.

The Lender selection stage 108 commences after the Dealer 12 has obtained a quotation for the customer at the quotation stage 102 and proceeds to obtain more accurate quotations based on the Lender pricing sheets 74 without the need to contact the Lenders 14. The system determines at step 150 whether any Lenders 14 have agreed to have business relations with the Dealer 12 and the process continues with those Lenders only. The process ends at step 152 if there are no Lenders 14 with an agreed relationship with the Dealer 12. Tables 94 defining Lender-Dealer relationships are stored in the system database 28 and there is one such table for each Lender 14. An example of a table 94 defining the Dealer-Lender relationships is shown in FIG. 14. As can be seen, fields are provided for Lender 14 and system identifications for defining whether a relationship exists 156, and if so the date of the already existing relationship 158. Fields are also provided for specifying the date of the next review 160, for indirect data dealing (including any special ID's) 162 and details of any stocking loan arrangements 83 and documents 166 received from Dealers 12 and their customers 26 to provide the deal. The table 94 also identifies whether a specific Lender pricing sheet exists 168 between a particular Lender 14 and Dealer 12.

Next the process obtains the customer data 84 (obtained by the dealer at step 132 of the quotation stage 102 and stored in the system database 28) at step 170 and the system 10 then checks at step 172 for specific overriding conditions that may be set by Lenders 14 in their pricing sheets 74 using the captured customer data 84. These could include conditions such as: the Lender 14 has set up only a pricing sheet 74 for HP and not PCP indicating that he deals only with HP; Lender 14 does not deal with vehicles of age over x years; Lender 14 does not deal with used vehicles having mileage over x miles etc. Lenders 14 whose specific overriding conditions have not been met are excluded from further consideration in the process.

The Dealer's set-up is then accessed at step 174 to see if the Dealer 12 has given priority to certain Lenders 14. The Dealer 12 is allowed by the system 10 to set up to three priority Lenders 14, where the priority overrides the commission calculations, and those Lenders 14 rank higher even though their commissions may be lower. In this regard, if the Lender 14 does have a specific relationship then a score for the Lender 14 is increased at step 176. Otherwise the score for the Lender 14 is not changed. The score is subsequently added to by the results of the scoring questions 88.

The customer 26 is then compared at step 178 against the Lender filtration sheets 74 and the scoring of prime Lenders or sub-prime Lenders using the fitering rules 76 is carried out Based on the results and the rules, a set of Lenders 14 are selected at step 180 that are likely to accept the deal. The commission applicable to each selected Lender 14 is calculated at step 182 using the quotes obtained from the Dealer quotation system, the Lender pricing sheet 74 and the specific Lender pricing sheet (if any). The selected Lenders 14 are displayed to the Dealers 12 in a sorted (ranked) order which is governed by criteria previously selected by the Dealer 12. Under a manual selection option, the Dealer 12 selects one of the Lenders 14 in the ranked list. It is not necessary for the Dealer 12 to accept the highest ranked Lender 14 if the approval is being carried out manually. However, under automatic approval, the highest ranked Lender 14 is selected automatically without any requirement for Dealer 12 input at this stage. A proposal is subsequently sent to the selected Lender at step 110.

The Lender filtration Step 178 of FIG. 13, namely the system's assessment of the likelihood of a successful proposal to a given Lender 14 (based on the Lender's criteria) is now described in overview.

Each time a customer 26 approaches a Lender 14 for funding via the Dealer 12 and the system 10, the system 10 acting on behalf of the Lender 14 assesses the credit standing of the customer 26 by analysing the customer data, vehicle data (and financing data) previously entered by the Dealer 12 to obtain a Dealer quotation. Based on this data, the system 10 categorises the customer 26 into one of several levels, in this embodiment Platinum, Gold and Silver credit levels. For customers 26 categorised into certain of these credit levels, detailed scoring is carried out using the pre-stored system scoring questions 88 if the system scoring option has previously been selected by the Lender 14. The purpose of the scoring is to confirm that the Lender's filtration process has classified the customer into the correct level. The results of the scoring can cause a customer 26 to be moved down one or two category levels but cannot cause the customer to be rejected on the basis of the screening results alone. The Lender 14 also specifies cut-off scoring levels which define the boundaries of the credit levels as confirmed by the scoring questions 88. These Lender-specified boundaries may be defined by the number of rejections (denies), referrals or acceptances generated by detailed system scoring questions or by an actual weighted score produced by the system scoring questions. The Lender specifies cut off levels defining the boundaries between each of the above mentioned categories. These cut off levels can be adjusted as required if there are repeated discrepancies between the results of the scoring questions and the filtration sheets.

Referring to FIG. 15, the Lender filtration process shown in Step 178 of FIG. 13 is now described in detail. The filtration process commences at the Platinum level of a particular Lender 14 with the question being asked at step 184 whether there are any further Platinum level questions to be answered by the customer data. If there are no further questions to be answered, then a Platinum rating is assigned at step 186 to the customer and the scoring process is commenced at step 188. If however there are questions to be answered, and this will always be the case initially, the customer data is applied at step 190 to the next question in the Lender's filtration sheet 74. The answer is stored at step 192 and can be one of three possible outcomes (Accept, Refer, Reject). If the answer is at step 194 Accept or Refer, then the process returns to the question of whether there are any further Platinum level questions to be answered at step 184 . Alternatively, a rejection on the Platinum question results in the Platinum assessment questions being stopped and the customer being moved down at step 196 to the next level, Gold in this embodiment.

The filtration process proceeds similarly for the Gold and Silver levels as it did with the Platinum level with the question being asked at step 198 are there any more Gold level questions, and if there are none then the Gold level being applied at step 200 to this customer 26 for this Lender 14 and scoring commencing at step 202. Alternatively if there are, the next Gold level question is asked at step 204, with the results being stored at step 206 and being used to determine at step 208 whether to return to further Gold level questions at step 198 or to drop down at step 210 to the Silver level when the answer is a reject On the determination of a Silver level, the Silver level rating is applied at step 212 but no scoring is carried out This is because the purpose of scoring is to determine whether the categorisation level needs to be adjusted downwardly but without rejecting the customer who has been considered to be acceptable by the Lender's filtration sheets 74. Accordingly, in the case of the Silver category, scoring serves no purpose. If there is a single rejection answer of the Silver level questions then the customer is rejected by this Lender 14 and the system 10 issues at step 214 a final decision of a rejection which is subsequently communicated to the customer 26. However, if this is the case, the result will have no effect on the customer's credit rating as no credit rating bureau will have been contacted in this process.

If at least one “refer” decision is encountered in the filtration at a given level, the proposal will be labelled with a likely outcome of ‘refer’ together with a quotation suitable for the level of filtration which has been determined.

The level that the customer successfully clears without meeting any “reject” is taken as the price level ceiling for scoring. This implies that at the end of scoring, if the price level turns out to be higher than this, then the price determined by the Lender filter level is taken as the price level for that customer.

Customer scoring, which is optional, provides a weighted average score and the number of accept, refer and reject decisions (called accept, refer and reject points) encountered by the customer in the scoring. The process first calculates the weighted average score and the points for the customer; second, and adjusts the above based on the tolerance rules specified in the Lender's tolerance sheets 77. The scoring is a standard process which is based on rules not determined by the Lender 14. Accordingly, the Lender 14 uses the tolerance sheets 77 to adjust the result to reflect their desired outcome of the scoring.

The system 10 sets up the questions against which the customers 26 are to be scored (the scoring questions). This is a set of fields that are selected from the pre-defined list of fields. Each field has a weight against it, and each of the options of that field have a score. The weighted average score is calculated by comparing the customer's data against the scoring questions. For each match, the corresponding score is taken, along with the weight for that field. At each match, the corresponding decision is also checked, and based on the decision, an accept, refer or reject point is awarded. Finally, a weighted average score and the total number of points for the customer are calculated.

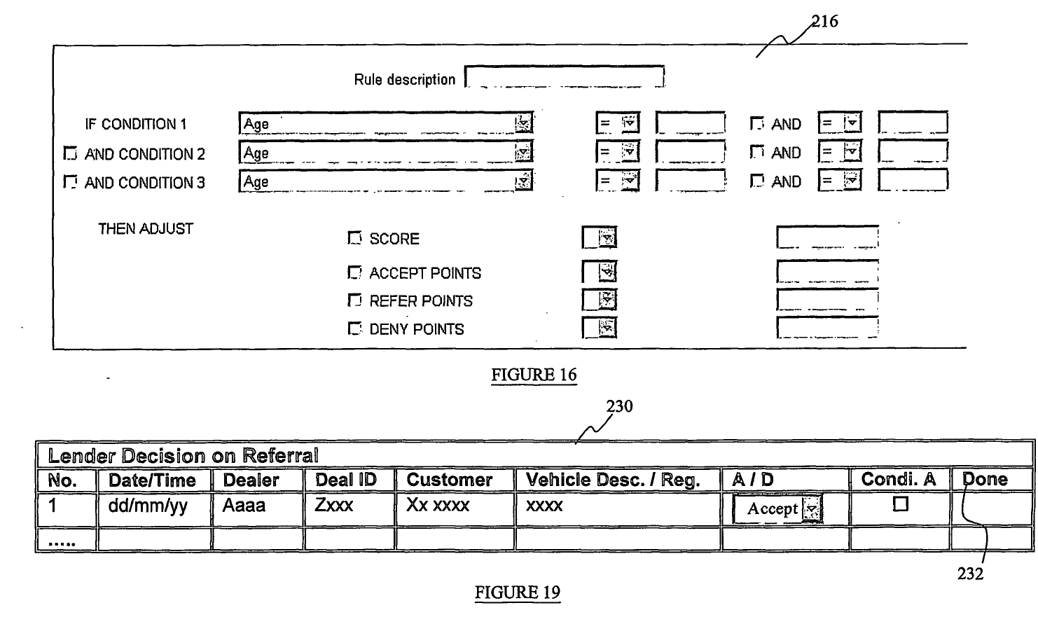

The calculation then proceeds to the Lender specified tolerance rules as set out in the tolerance sheets 77 which are provided to permit multi-variable decisions to be made that mimic the behaviours of underwriters. The customer's data is compared with each of the conditions specified in the tolerance sheets 77. For each perfect match of conditions, the corresponding adjustment to the score and the points is made. FIG. 16 shows a tolerance sheet 77 (unpopulated) which specifies the conditions to be met and the action to be taken as a result. At the end of comparison with tolerance rules of the tolerance sheets 77, the final tally of score and the points for the customer is compared against the scoring cut-offs set up by the Lender. Based on the range in which the customer lies, the decision and price level is awarded, subject to the price level ceiling from the filtration.

The system 10 sets up the scoring questions, the weights, the scores, and the decisions. The Lenders choose their own cut-offs from their set up screens as well as their and their tolerance sheets 77. However, the system 10 provides them with recommended cut-offs which they can compare against

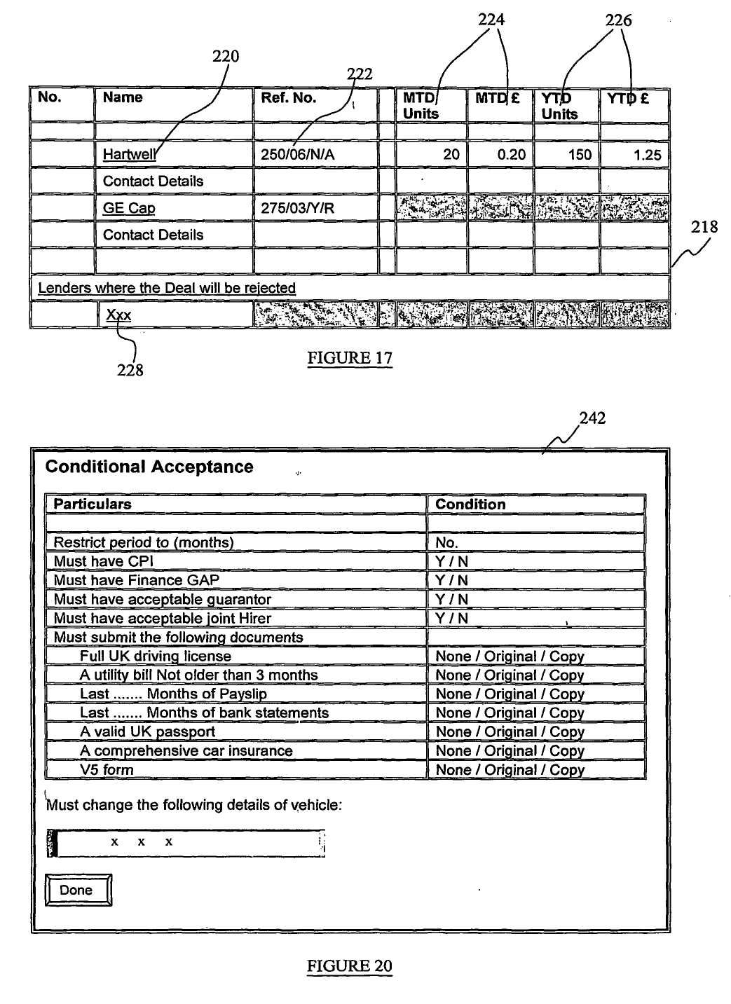

The Lenders 14 that are selected by the system 10 for sending the proposal, are displayed in a tabular form 218 as shown in FIG. 17. The Lenders are usually ranked according to the highest commission offered though other Dealer desired criteria such as debit back periods can alter the ranking. The Dealer can choose to see either all Lenders whose filtration sheets have indicated “accept” or “refer” and to display only those with “accept” or only those with “refer”, along with another option to display only prime Lenders. The Lender names 220 are hyperlinked to the form containing the list of documents required from the customer 26, as set up by the Lender 14 on the system 10.

Each row in the table 218 represents a Lender and includes a reference number 222 which actually displays information for the benefit of the Dealer 12 when choosing which Lender 14 to send a proposal to. The reference number 222 provides the following information: commission (net of the system administrator's commission)/debit back period for cancellation/whether payment of commission with payment of balance/whether the Lender filtration sheet on the system has indicated an accept or a refer.

In the example shown in FIG. 17, the Lender Hartwell is paying £250 as commission, has a condition that if any deal is cancelled within six months the commission will be debited back, does not pay the commission with the payment of balance funded, and the filtration sheet has indicated an accept. If a Broker is logged in rather than a Dealer 12, this displays the total commission, Dealer's commission and his commission (see second embodiment).

For Lenders 14 where there is a stocking loan arrangement 83, there are month to date unit “MTD U/£” 224 and year to date unit “YTD U/£” 226 fields displaying the statistics on the number of deals conducted with these Lenders 14 and the value of these deals. These fields are blank for Lenders 14 where no such arrangement exists.

A link 228 at the bottom of the table 218 displays the Lenders 14 where the filtration on the system 10 has indicated that the deal is rejected. The Lender name is hyperlinked to a page (not shown) that shows what caused this result For instance, it could be due to the low score, or due to one of the overriding constraints placed in the Lender pricing sheet 74. Each Lender 14 occupies two rows, with the second row containing the contact details of the Lender as entered by him.

The existence and status of a stocking loan arrangement (described in detail later) 83 may also be a factor in ranking a Lender 14. If targets of the stocking loan arrangement 83 have not been met, the particular Lender 14 can be pushed to the top of the list As seen in the example of FIG. 17, although GE Capital appears to be offering better terms overall to the Dealer 12, the system 10 has placed Hartwell Finance at the top due to the pending stocking loan obligations of the Dealer 12.

The Dealer 12 can save the deal on the web site without making a proposal, which records the status of the potential proposal as “not proposed”.

The Dealer 12 can manually select which Lender 14 to send a proposal to (manual proposal). or allow the system to proceed with the proposal stage based on the rank of the Lender (automatic proposal). In case of Dealer groups, the system 10 can be configured to enable the Dealer head office (HO) to disallow the Dealer 12 from selecting which Lender 14 to make the proposal to. In that case, the Dealer 12 is only able to proceed in sequential order as it appears in the table 218. This applies only for the manual proposal. In the automatic proposal, the system proceeds only in sequential order.

The Dealer 12 may wish to select a particular Lender 14 on the basis of the likelihood of the Lender 14 to accept a deal or refer to underwriters, on how the Lender 14 will pay the commission to the dealership (monthly, quarterly, annually), and/or on the debit back period. These factors can be programmed into the ranking of the results and hence for effecting the automatic proposal.

New Dealers on the system 10 can compare the commissions that can be earned through the system 10 with their existing arrangements by entering the details regarding the existing arrangements with a Lender 14 into the system 10. At the time of selection of Lender 14, the system 10 calculates the commission payable from both the existing arrangement and from the Lenders 14 on the system 10. Both results are displayed to the Dealer 12, and the Dealer 12 chooses where to make the proposal. If he chooses to make the proposal to a Lender 14, the system 10 proceeds as explained below. If the Dealer 12 chooses to make the proposal to his existing Lender, the proposal is sent via fax. For this, the Dealer 12 enters the contact details of that Lender.

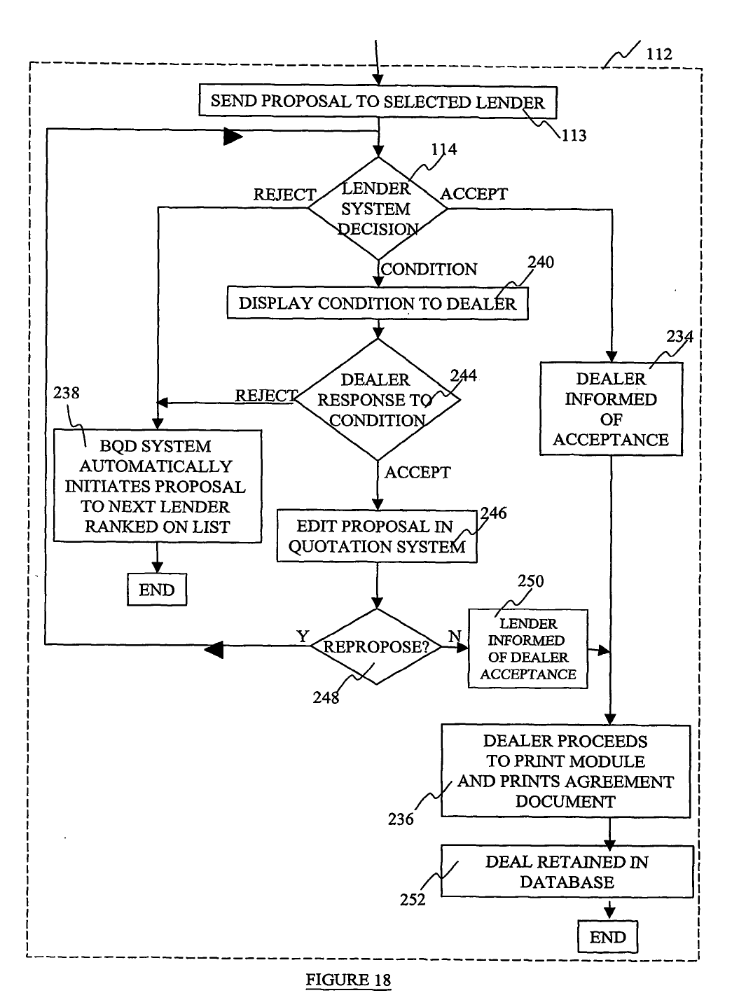

As has been previously described, the proposal can be made to the Lenders 14 manually by the Dealers 12 or automatically by the system 10 under the control of the proposal module 52; the Dealer 12 specifies his preference during registration. FIG. 18 shows the entire proposal stage in detail.

The proposal stage 112 commences with the system 10 generating an export file (XML) of the proposal details, which is transferred directly to the Lender's system at step 113. The Lender's system then processes the information using its secret algorithm 18 and generates a response file containing the credit decision at step 114. The Lender's decision is stored on the system 10 in the form of a table 230 (FIG. 19) and this informs the Dealer 12 of an accept, reject or accept with conditions decision. When the ‘done’ box 232 is marked, it indicates that the Lender 14 has finished updating the current record and so the system 10 generates the appropriate message for the Dealer 12.

The system 10 is arranged to utilise a time out function whereby each Lender 14 has set up a maximum time period within which a response to a proposal will be sent If no response is received within this time period, then the BQD engine 24 either sends a message to the Dealer 12 asking him to select another Lender 14 (manual mode) or simply sends a proposal to the next Lender 14 in the ranked list (automatic mode). Any responses received after the end of the Lender specified time period are not accepted and the Lender 14 is informed of this.

If the Lender accepts, at step 114, the proposal without conditions, the system returns to the Dealer with an acceptance at step 234 and documents ready for printing at step 236 (the system stores blank pro-forma versions of the print documents required by the Lender 14). The response file contains information to fill the blank fields in the pro-forma documents, so that the Lender's documents can be printed directly from the system 10. While the system 10 is proceeding with the auto propose routine, the Dealer 12 can commence the proceedings for the next customer: accepting the details of the next customer and making a quotation, etc.

If the Lender's decision at step 114 is to reject the proposal, the system under automatic mode of operation initiates at step 238 a proposal to the next Lender on the selected Lender list without customer involvement.

If the Lender accepts, at step 114, the proposal with some conditions, the conditions are displayed at step 240 to the Dealer in a table 242, as shown in FIG. 20, and the Dealer 12 must decide at step 244 whether to accept or reject these conditions. The Dealer 12 can specify whether he wants the system to ignore conditional acceptance. If so, any conditional acceptance is treated as a rejection of the proposal.

If the Dealer accepts the condition, the Lender ID is remembered and Dealer 12 is taken back to the quotation stage 102 and makes at step 246 the required modifications to the Dealer quotation. At step 248, he can choose to repropose to the same Lender, or accept the conditions, or to go through the filtration and Lender selection stage 108 again, in which case he may not be able to repropose to the same Lender, depending on the results of the new filtration. On acceptance of the conditions, the Lender is informed at step 250 and the Dealer 12 proceeds at step 236 to the print module and prints the agreement document.

The history of the proposal in terms of the Lenders to whom the proposal was made, the time and date stamp of the proposal and their response, is stored at step 252 with the customer details in the database 28 for examining the history the next time the customer 26 visits the Dealer 12. Also, it helps the system 10 in identifying those Dealers 12 where the system 10 is used more for making a quotation and for checking the filtration, without actually making the proposal to any Lender 14.

It is to be appreciated that simultaneous proposals, for up to three Lenders 14, can be sent by the system 10. In this case, under the automatic mode of generation proposals would be sent out to the top three ranked Lenders 14.

Dealers 12 can also choose at the time of the proposals being sent whether they would prefer a manual proposal system. This operates in much the same way as the automatic system described above, the difference being that on receiving the acceptance from the Lender 14 at step 234, the system administration personnel download the print documents and store them on the system 10. These personnel update the system 10 regarding the deal status. The Dealer 12 can access the documents over the system 10 and print the documents.

A deal update feature is provided for certain fields such as vehicle registration number, VIN, date of delivery, etc. that are not available at the time of submitting the proposal, or that may be needed to be changed later. On the system 10, these fields are not mandatory at the time of submitting the proposal. However, these fields are mandatory in the print module, which does not display the complete document for printing unless these fields are filled. Some of the fields are not mandatory (CPI, Gap insurance type, MOT premium, car insurance details, warranty) even in the print module, and the Dealer can write them by hand on the printed document.

Each time a deal is updated with some information, an XML file is generated for the Lender 14 to import this information into his system 10. An option to view updated deals is provided at the start page of the Lender 14. From the viewing page, the Lender 14 has the option to save the XML file. For a Lender 14 where the systems are already online, the system automatically sends the XML file on deal updating.

The BQD engine 24 monitors the status of the enquiry and any resultant proposal. Any deal proposed through the system 10 passes through the following possible stages: not proposed, proposed, referred, rejected, accepted, cancelled, printed, reproposed, delivered, documents received. The BQD engine 24 marks the status of any deal on the system 10.

Smooth functioning of the system 10 requires message transferral which may include messages generated by the system 10 and messages sent between participants. The system 10 automatically generates messages in the following scenarios:

When a Dealer 12 makes an online application and has been approved for business by the system 10, Lenders 14 and suppliers of other products are informed of the application so that they can proceed to their Approval/Review forms to accept or reject the Dealer's Application This informing message is generated automatically by the system and is sent as an e-mail to the designated e-mail address of the Administration User at the Lender 14 or supplier.

Whenever the Dealer's status with a supplier/Lender is changed, the Dealer 12 is informed by an e-mail. For example, a Dealer's application may be approved, or an existing relationship may be terminated by the Lender/supplier. In either case, the Dealer would be informed by the system 10 through an e-mail.

Dealers 12, Lenders 14 and suppliers maintain their profiles on the system. This mainly includes the key information about the participant (contact information, names of directors, etc). Each time any participant changes the profile, other participants with whom he has a relationship on the system 10 are informed by the system 10 through an e-mail. Each time a pricing sheet 74, 80 is changed by a Lender/supplier, a Dealer 12 receives a message informing him just of the fact that a change has been made and that henceforth his commission calculations may change. Each time a Lender/supplier wishes to change a pricing sheet 74, depending on the notice period specified by the Lender 14 in the Lender pricing sheet 74, the changes take place only after that period. In the meantime, the system 10 generates a message to all participants that the pricing sheet 74 is about to be changed after the specified period. Each time a participant is removed from the system 10, all other participants with whom the removed participant had a relationship will be informed through an e-mail generated by the system 10. Each time a Lender 14 or Dealer 12 change the specific Lender pricing sheet, the other party to the pricing sheet is informed and asked for confirmation of the same.

On receiving an accept decision to a referral from a Lender 14, a Dealer 12 may decide to take up the deal and print the necessary documents. In such a case, all other Lenders 14 where the deal is currently lying are informed by the system 10 that the deal is through and they need not process it any further by a message viewable from their messages pages.

In addition to the automatic message generation, Dealers 12 and Lenders 14 have the option of attaching their own messages to the proposal. These messages are transmitted as text along with the proposal, and are a part of the entire deal when it is stored on the system 10, enabling use for future reference.

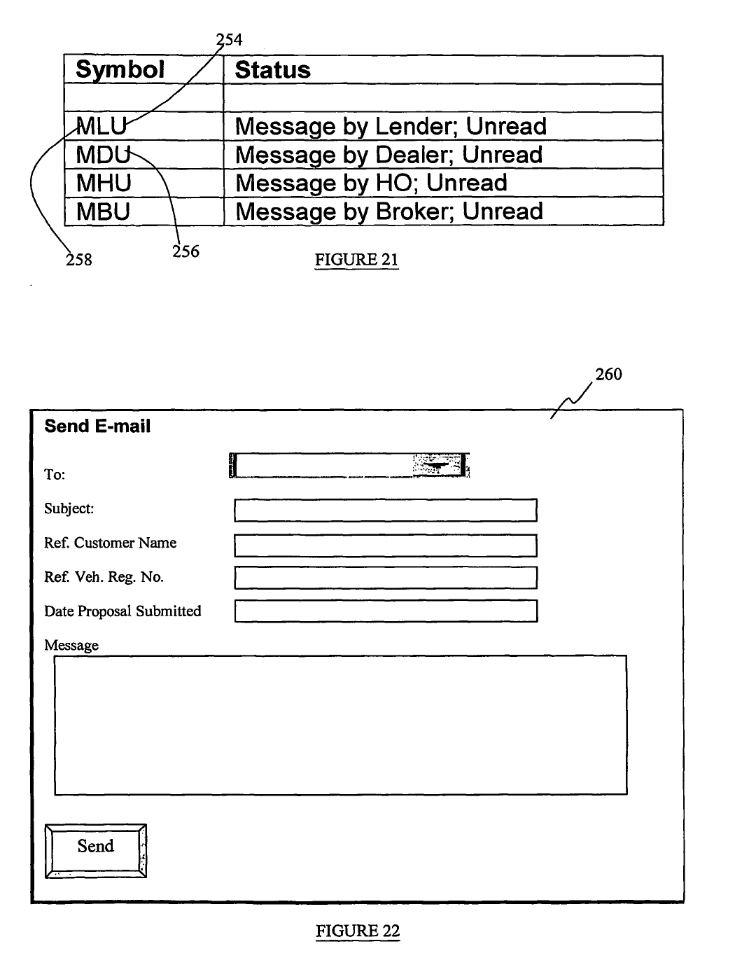

All messages attached to a proposal are tracked for the date and time when they were sent, added to the message by the time and date stamping module 58, and when they were read by the recipient Each message has a status indicator (symbol) denoting whether or not it has been read, and from whom it originated. The status indicators used are shown in FIG. 21. Once the message has been read, the “U” 254 is replaced by “i”, to indicate “Read”. For messages that have been replied to, the status changes accordingly. For instance, if when a Dealer sends a message to a Lender, the first status is MDU 256. As soon as the Lender reads it, the status changes to MDR. When the Lender has replied to the message, the status changes to MLU 258. Once the Dealer reads it, the status changes again to MLR Therefore, at any point of time, the symbol reflects the current status of the messages attached to the proposal, namely who originated the latest message and whether it has been read

Participants also exchange e-mails between themselves to enable communication related to system deals. This e-mail facility is not available as a general e-mail facility. It is possible to only send e-mails to the mailboxes of participants on the system. For instance, a Lender 14 can send an e-mail to a particular Dealer 12 about some issue related to a particular deal, etc. The form 260 for sending these mails is shown in FIG. 22. The form 260 is picked up automatically by the system 10 depending upon which participant is sending the mail, and the time stamp is picked up from the time and date stamping module 58.

A stocking loan specification 83 is part of the system 10 in that Dealers 12 are provided with loans for their use in stocking vehicles and these loans are secured by the vehicle stock held by the Dealer 12. Dealers 12 can also purchase vehicle stock using these loans for re-sale to their retail customers 26.

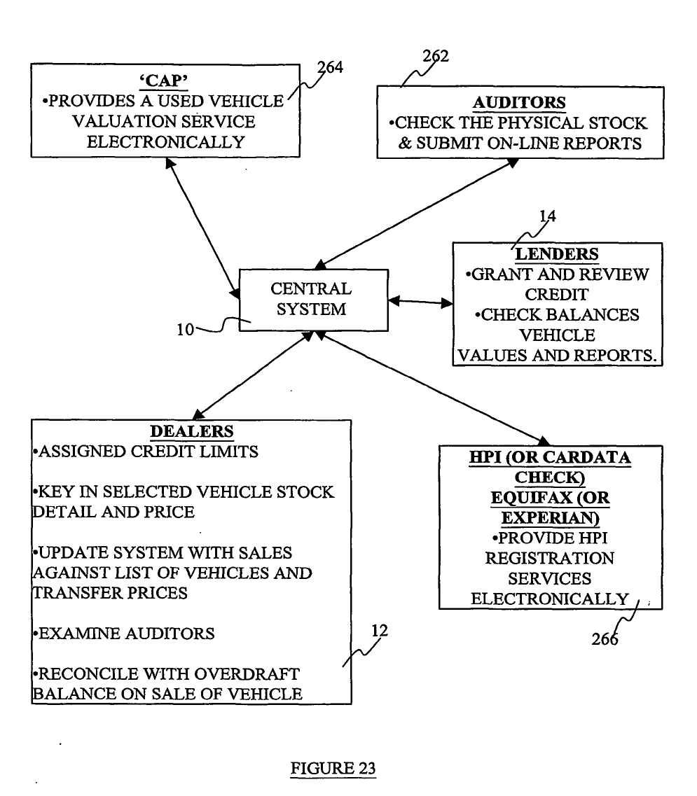

The system 10 also provides a stocking loan facility and this is represented diagrammatically in FIG. 23. The system 10 provides vehicle stock data capture, hire purchase insurance facilities, and vehicle valuation against CAP, which are all accessible by the Auditors 262 and Lenders 14. More specifically, using the existing system 10, Dealers 12 can be accessed for inputting key vehicle stock details and price. Dealers 12 have agreed credit limits for any stocking loan arrangement and update the system 10 with sales information against the list of vehicles and their transfer prices. Auditors 262 seeking permission to view Dealer 12 information can be checked and subsequently for any sold vehicles the overdraft balance can be adjusted to account for re-payment of the part of the stocking loan attached to the vehicle.

The system 10 connects together these Dealers 12, with stocking loan Lenders 14 who can grant and review credit and check balances with vehicle values and sales reports. Auditors 262 connected to the system 10 can check physical stock and submit online replies. The system 10 is also connected to a CAP database 264 which provides an electronic valuation of the vehicle and to a HPI or like service 266 which provides HPI registration services to record the loan against the vehicle.

As mentioned previously, each Dealer 12 is given a credit limit by a Lender 14. Dealers 12 then select the vehicles they want to purchase and key the details into the system 10. Vehicles are valued by the system 10 at the trade price multiplied by the percentage loan to trade price that the Lender 14 would want to lend against The Lenders 14 interest in the vehicle is registered through the HPI system 266. The system 10 shows the cash to be provided by the Lender 14 to finance the stock. The Lender 14 draws the cash from the nominated account The Dealer 12 sells the vehicles and updates the vehicle stock record. Payment is made by the Dealer 12 into the Lender stocking loan account Lenders 14 can check the stocking loan account against the vehicle stock at any time, relying on the Dealer's input and auditor's report Auditors 262 check stock at random and submit a report online to the Lender 14. A self explanatory example of a stocking loan arrangement 83 is set out in Table 1.

TABLE 1

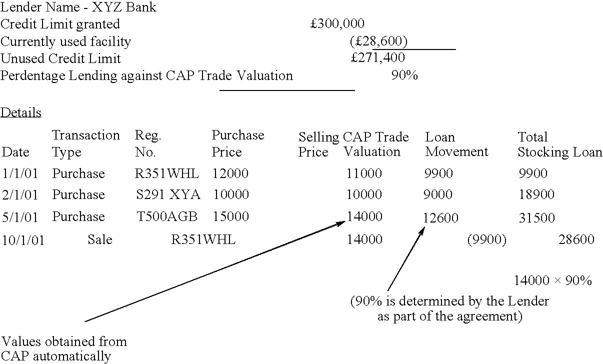

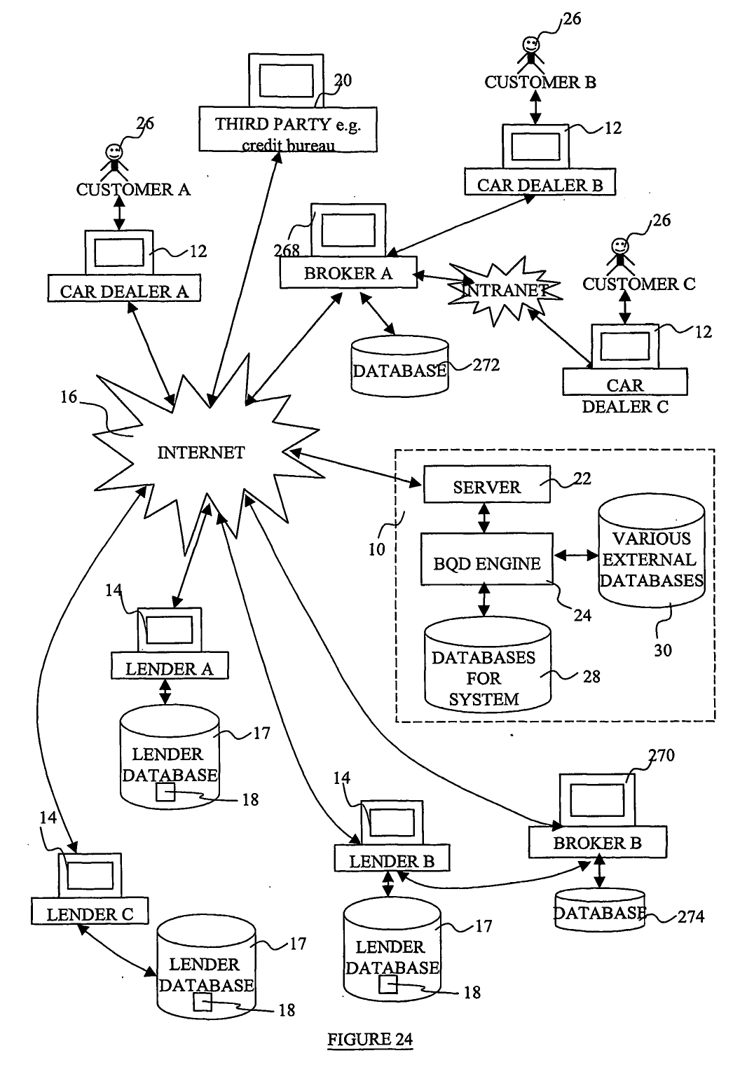

Referring now to FIG. 24, a second embodiment of the present invention is described. The second embodiment is very similar to the first embodiment and accordingly, the present description is restricted to the differences between them. The main difference is the introduction of Brokers as additional participants on the system 10.

In the second embodiment of the present invention, the Brokers may act as Lenders or Dealers as shown in the system diagram in FIG. 24.

Franchised Brokers acting on behalf of Dealers 12 are appointed within this embodiment to deal with the Lenders 14 as the Dealers 12 (B and C) are not large enough to do so themselves. As users of the system 10, Brokers have elements of both Lenders 14 and Dealers 12. In FIG. 24, Broker A 268 acts for Dealers B and C and Broker B 270 acts for Lenders A and B. Broker A 268 and Broker B 270 may also have their own respective databases 272, 274.

A Broker 270 acting as a Lender (Broker B) has its own pricing sheets on the system 10 similar to the Lender pricing sheet 74 with three levels of pricing that have to be taken into account for calculation of commission Broker B 270 specifies the minimum level of commission that he should receive from the deals that he proposes via the system 10. For example, if the interest rates set up by the Lender 14 where the deal has been accepted is such that Broker B 270 stands to get commission below his minimum level, then the system 10 generates a message to that effect to Broker B 270, and allows him to proceed to sub-prime Lenders instead of taking up that accepted deal If Broker B 270 chooses to do so, the concerned Lender 14 whose acceptance is not being taken up, is informed by a message generated by the system 10.

The system 10 calculates the commission as follows:

1. The difference between the pricing in the agreement with the customer 26 and the Lender pricing sheet 74 is the total commission;

2. The difference between the pricing in the agreement with the customer 26 and the Broker pricing sheet is the commission to the introduced Dealer 12 (Dealer introduced through Broker and not doing business directly on the system); and

3. The difference between the total commission and the introducing Dealer commission is the Broker's commission.

Broker B 270 also sets up his own list of documents required from introduced Dealers 12 and their customers 26, similar to the facility described for Lenders 14. Broker B 270 reviews applications from Dealers 12 to do business with him, similar to the facility described for Lenders 14. Each time an introduced Dealer 12 sends a proposal to Broker B 270, Broker B 270 has to respond to the introduced Dealer 12 with the Lender's decision. This functionality is similar to the one described for Lenders 14.

The difference is that while the Lender 14 uses this facility only in case of referrals, Broker B 270 uses this facility for each proposal made by the introduced Dealer 12. Each time an introduced Dealer 12 sends a proposal to Broker B 270 , Broker B 270 has to receive a message from the system 10 that a proposal has arrived and needs his attention. This is done through an e-mail to the designated e-mail address of the Broker administration user.

Each participant on the system 10 can update all the information provided at the time of registration.

This includes information about the company, the directors, the contact information, the process details, etc. Each time a participant updates or modifies the information, other business associates are informed by the system 10. Broker B 270 can access most reports generated for Lenders 14.

Broker A 268 acting as Dealer 12, is able to apply to conduct business with Lenders 14 on the system 10. The Broker application form is similar to the application of a Dealer group. The person completing the application has the option of saving the information entered without submitting it to the system 10, to enable him to complete the application later. Broker A 268 is then analogous to the head office (HO) and the introduced Dealers 12 to the Dealership branches and is treated as such for purposes of commission calculation and for user access rights. Each introduced Dealer 12 is, however, checked against the Dealers 12 and introduced Dealers existing in the system 10. In case he already exists on the system 10, his registration through Broker A 268 will not be allowed, in order to ensure that each ID uniquely identifies one Dealer 12. Broker A 268 has access to the quotation system and can make a proposal to Lenders 14. If a proposal made by Broker A 268 is marked for referral by the Lender's system, the system 10 ensures that Broker A 268 receives an intimation about the Lender's decision at the appropriate time.

Brokers or the system personnel may introduce new Dealers 12 as system 10 participants. This functionality forms a part of the Broker functionalities. During set-up 100, such Dealers 12 can enter the following information:

1. Introduced by: Name of Broker, or system personnel

2. ID of Broker

For the system 10, the following additional set-up is required:

1. Commission payable: £/deal or % of earnings from that customer

As part of the set-up, the Dealer 12 has an option to specify whether for such deals, the system 10 can find a Broker to place the deal with some Lender (referred to “Lender of Last Resort” or LLR). These deals are then sorted out by post code by the BQD engine 24 and sent to the appropriate Broker (such as Broker B 270) based on the post code. For the Broker's set-up, he has to specify the five sub-prime Lenders who would fall under the LLR category.

Once the Broker 268, 270 receives these deals on an Active List, he can view the details and even edit them—for instance, asking the customer the sub-prime questions that have not been previously asked and entering the answers. Also, the Broker can attach free text to the deal. From this page, the Broker can select the Lender whom this proposal should be sent to. For this, a list of his LLR is displayed and he can initiate proposal by fax from here. He can also view the Dealer's name and telephone number.

For these Brokers 268, 270, they can view a report displaying to them the commission payable to the system, the commission payable to the Dealer 12 and the total commission payable by the Lender 14. The system 10 can mark that for these deals, for how many has commission actually been received.

The system 10 can also provide its own brokerage services to Dealers 12. As part of this, the following services are provided:

1. Input data and make proposal to get best deal

2. Print documents and post to Dealer for signatures

3. Receive all documents to check compliance with Lenders' requirements

4. Get cheque from Lender, to collect payments on behalf of Dealer

5. Sort direct debit problems between Lender/Dealer.

Whilst the first and second embodiments have been described with the Lender filtering and scoring stages being complimentary, it is to be appreciated that the Lenders 14 do not have to use the system's scoring facility. In this case, each filtering category would have an estimated quotation price associated with it which would represent the Lender's likely rate of supplying the financing. The commission for the Dealer 12 could also be calculated from this price. With three categories, this is a very coarse estimator but with the provision of further categories, as is possible with the present invention, the estimate quotation can be more specific (providing different quotations for slightly different types of customer).

Whilst not previously described, both embodiments are capable of implementing reverse quotation logic. This is a facility which is made available for Dealers 12, particularly useful for cases where Dealer has a commission in mind, and wants to select a Lender 14 where chances of getting accepted with a low APR are the highest. The reverse quotation logic requires the Dealer to capture customer and quotation details, to enter the commission the Dealer desires, for the system to select the Lender with lowest total finance charges [after adding Dealer's required commission] from amongst those indicating Acceptance in the Filtration. From these finance charges, the system would calculate the APR and the Monthly Installments.

These two quotations are displayed on the screen, and the Dealer has the option of printing a Written Quote or of sending the proposal to that Lender.

It is also to be appreciated that in this case the tolerance limits can be applied to the filtering rather than the scoring process. In this regard, the Lender 14 would set up the standard filtration rules 76 and pricing sheets 74 and would specify in the tolerance sheets 77 how special promotions targeted at specific types of customer 26, within a particular category for example, would be implemented. Accordingly, the tolerance sheets 77 could represent transient promotions and could simply be deleted at the end of the promotion without affecting the set up of the filtration rules 76 or the pricing sheets 74.

Having described preferred embodiments of the present invention, it is to be appreciated that the embodiments in question are exemplary only and that variations and modifications such as will occur to those possessed of the appropriate knowledge and skills may be made without departure from the spirit and scope of the invention as set forth in the appended claims. For example, even though three kinds of acceptable grading have been shown for the filtering process, it is possible to have any number of levels, with the more levels there are, the more precise the categorisation is. In addition, even though the present invention has been described in relation to a single dealership, it is to be appreciated that that the system is specifically designed to operate with multiple users.

1. A system for selecting one of a plurality of distributed processing entities that each are arranged to process a data set of user-specified criteria to determine a multi-parameter assessment of that data set, the system comprising:
receiving means arranged to receive the data set via a communications network from an intermediary acting on behalf of the user;
an estimation engine for executing a plurality of estimation algorithms, each algorithm being provided by one of the plurality of processing entities and being arranged to generate an approximation of the corresponding multi-parameter assessment by consideration of a processing-entity selected subset of the data set of user-specified criteria; and
a selecting module for selecting of one of the processing entities, the selecting means being arranged to consider the generated approximations and select the processing entity whose approximation maximises one or more performance criteria for the intermediary.

2. A system according to claim 1, wherein the user-specified criteria comprise personal data regarding the user.

3. A system according to claim 1 or 2, wherein the multi-parameter assessment comprises a multi-parameter quotation.

4. A system according to claim 3, wherein the multi-parameter quotation includes the parameters of time and monetary value.

5. A system according to any preceding claim, wherein the system further comprises a proposal engine for generating a proposal to the selected processing entity, the proposal including the data set of user-specified criteria.

6. A system according to claim 5, wherein the proposal engine is arranged to receive the multi-parameter assessment of that data set and to communicate the same to the intermediary via the communications network.

7. A system according to claim 6, wherein the proposal engine is arranged to transmit a received conditional assessment from the selected processing entity to the intermediary and to transmit a received intermediary-amended proposal back to the selected processing entity in response.

8. A system according to any of claims 5 to 7, wherein the proposal engine is arranged to transmit a plurality of different proposals to different processing entities before the proposal engine has received a response from any of the processing entities.

9. A system according to any preceding claim, wherein the selecting module is arranged to automatically select the processing entity associated with the generated approximation based on one or more pre-stored intermediary-determined performance criteria.

10. A system according to claim 9, wherein the system is arranged to process requests from a plurality of intermediaries received via the communications network and the selecting module is arranged to store one or more predetermined performance criteria for each intermediary.

11. A system according to claim 9 or 10, wherein the selecting module comprising ranking means for ranking the approximations on the basis of the intermediary-determined performance criteria.

12. A system according to claim 11 as dependent on any of claims 5 to 8, wherein the proposal engine is arranged to send a proposal automatically without any intermediary interaction to the processing entity associated with the next highest-ranked approximation.

13. A system according to any preceding claim, further comprising a set up module for each processing entity setting up and configuring their respective estimation algorithms.

14. A system according to any preceding claim, wherein each estimation algorithm comprises a plurality of sheets of filtration questions for grading the data subset into one of a plurality of categories, each category having associated therewith a set of values for the required approximation to the multi-parameter assessment.

15. A system according to claim 14, wherein the plurality of filtration sheets include a data set rejection grading and the selecting module is arranged to exclude the associated processing entity from possible selection if the estimation algorithm indicates a result of a rejected data subset.

16. A system according to claim 14 or 15, wherein the filtration sheets are arranged in a hierarchical order, and the estimation engine is arranged to apply the highest filtration sheet to the data subset first and if the result of any question is a reject, to continue with questions from the next lower filtration sheet in the hierarchy.

17. A system according to any of claims 14 to 16, wherein the estimation engine is arranged to label the data subset with the results of the estimation algorithm in terms of the numbers of accept, reject and refer responses to the questions and the selecting module is arranged to carry out selection based on the numbers of accept reject and refer answers generated to the questions of the filtration sheets.

18. A system according to claim 16 or claim 17 as dependent on claim 16, wherein the selecting module is arranged to carry out selection on the basis of the hierarchical level at which the estimation engine concludes its estimation algorithm questions.

19. A system according to any preceding claim, wherein the estimation engine comprises an independent set of scoring rules which are arranged apply scoring questions to the data subset and independently score the data subset into one of a plurality of processing-entity defined ranges.

20. A system according to claim 19, wherein the scoring rules are arranged to store the number of accept, reject and refer responses to scoring questions and to generate a weighted average score of all the responses to the scoring questions applied to the data subset.

21. A system according to claim 19 or 20, wherein the estimation engine comprises a processing-entity defined tolerance function for adjusting the score generated by the scoring rules, wherein the tolerance function is activated to change the score or the number of accept, reject and refer responses, if a set of predetermined conditions are met.

22. A system according to claim 21, wherein the set of predetermined conditions are specified in terms of accept, reject and refer answers generated by the scoring questions and on the weighted average score.

23. A system according to any of claims 19 to 22 as dependent on any of claims 14 to 18, wherein the estimation engine is arranged to lower a category determined the filtration sheets on the basis of a lower score determined by the scoring rules.

24. A system according to any preceding claim, further comprising an intermediary approximation engine for determining, from an intermediary's experience, an approximation of the multi-parameter assessment of the data set and for communicating the approximation to the intermediary for consideration.

25. A system according to claim 24, wherein the intermediary approximation engine comprising a plurality of intermediary-selected filtration sheets of questions for grading an intermediary specified data subset into one of a plurality of categories, each category having associated therewith a set of values for the required approximation to the multi-parameter assessment.

26. A system according to claim 25, wherein the plurality of intermediary-selected filtration sheets include a data set rejection grading.

27. A system according to claim 25 or 26, wherein the intermediary selected filtration sheets are arranged in a hierarchical order, and the intermediary approximation engine is arranged to apply the highest filtration sheet to the data subset first and if the result of any question is a reject, to continue with questions from the next lower filtration sheet in the hierarchy.

28. A method of selecting one of a plurality of distributed processing entities that each are arranged to process a data set of user-specified criteria to determine a multi-parameter assessment of that data set, the method comprising:
receiving the data set via a communications network from an intermediary acting on behalf of the user,
executing a plurality of estimation algorithms, each algorithm being provided by one of the plurality of processing entities and generating an approximation of the corresponding multi-parameter assessment by consideration of a processing-entity selected subset of the data set of user-specified criteria; and
selecting of one of the processing entities by considering the generated approximations and selecting the processing entity whose approximation maximises one or more performance criteria for the intermediary.

29. A system for selecting a processing entity for generating a multi-parameter quotation for a user via an intermediary, the system comprising:
a plurality of processing entities operably connectable to a communications network, each entity including a secret processing algorithm for considering a set of personal descriptors of the user and generating a multi-parameter quotation based on the set; and
a central processing station operably connectable to the intermediary and processing entities via the communications network, the central processing station comprising:
means arranged to collect the set of personal descriptors of the user from the intermediary via the communications network;
a plurality of estimation algorithms each being provided by one of the plurality of processing entities and being arranged to generate an approximation of the corresponding processing entity quotation by considering a subset of the set of personal descriptors of the user; and
means for selecting of one of the processing entities, by consideration of the generated approximations, which maximises one or more performance criteria for the intermediary.

30. A method of categorising user-specified data for use in establishing the quality of that data for submission to a processing entity, the method comprising:
setting up a plurality of hierarchical sets of questions;
iteratively applying the user-specified data to each of the questions in the highest one of the sets until a negative response is received or there are no more question in the set to ask;
in response to receiving a negative response, repeating the iteratively applying step to the next set of questions in the hierarchy,
re-executing the applying and repeating steps for subsequent responses until either there are no more questions in the set to ask or the lowest level in the hierarchy has been reached; and
categorising the user-specified data as the lowest level in the hierarchy encountered by the user-specified data.

31. A method according to claim 30, wherein the setting up step comprises specifying the response to each question in each set of questions, wherein at least some questions in each set have three possible outcomes.

32. A method according to claim 31, wherein the three possible outcomes are accept, reject or refer.

33. A method according to any of claims 30 to 32, further comprising storing each of the responses generated by the applying steps.

34. A method according to any of claims 30 to 33, further comprising labelling the lowest level encountered by the user-specified data with the least desirable response encountered at that level together with the responses generated by the applying steps.

35. A method according to any of claims 30 to 34, further comprising applying a processing-entity defined tolerance function to the results of the categorisation step for adjusting the results of the categorisation, wherein the tolerance function is activated to change the numbers of different types of responses, if a set of predetermined conditions are met.

36. A method according to claim 35, further comprises repeating the applying the tolerance function step for each of a plurality of different tolerance functions each having a different set of predetermined conditions.

37. A system for categorising user-specified data for use in establishing the quality of that data for submission to a processing entity, the system comprising:
means for setting up a plurality of hierarchical sets of questions;
a processing engine for iteratively applying the user-specified data to each of the questions in the highest one of the sets until a negative response is received or there are no more question in the set to ask;
wherein the processing engine is arranged, in response to receiving a negative response, to select the next set of questions in the hierarchy and repeat the iteratively applying process thereto, and is further arranged
to re-execute the applying and repeating processes for subsequent responses until either there are no more questions in the set to ask or the lowest level in the hierarchy has been reached; and
to categorise the user-specified data as the lowest level in the hierarchy encountered by the user-specified data.

38. A messaging system for use with a plurality entities connected via a communications network, the system comprising:
creating means for creating a message code comprising a plurality of representative alphanumeric characters representing information concerning the status of an attached message, the entity from whom it has originated and identify the code itself, and
incorporation means for incorporating the message code into an electronic message transmittable between the entities.

39. A system according to claim 38, wherein the message code is provided within the content of the message.

40. A system according to claim 38 or 39, wherein the message is passable between a plurality of known categories of entities and a single character of the message code represents one of the categories of entities.

41. A system according to claim 38 or 39, wherein the message is passable between a plurality of known entities and a single character of the message code represents one of the pluralities of entities.

42. A system according to any of claims 38 to 41, wherein the creating means is responsive to actions carried out on the message and is arranged to change the message code to show the change in status of the message.

43. A system according to any of claims 38 to 42, wherein the system is arranged to send a plurality of messages together and the attaching means is arranged to attach an independent message code to each message.

44. A system according to any of claims 38 to 43, wherein the messaging system further comprises a time and date stamping module for time and date stamping each message in an independently verifiable way and storing the code at a central registry of the messages associated with the communication of the messages between the plurality of entities.

45. A system according to any of claims 38 to 44, wherein the creating means is arranged to create a three-character messaging code.

46. A system according to any of claims 38 to 45, wherein the creating means comprises a plurality of creating modules, with one module being provided at each entity's location on the communications network.

47. A system according to any of claims 38 to 46, wherein the attaching means comprises a plurality of attaching modules, with one module being provided at each entity's location on the communications network.

48. A system for effecting and administering a stocking loan from a lender to a dealer, the system comprising:
a processing station for monitoring the changes to the stocking loan; the processing station being connectable to a communications network linking together the dealer, the lender and an lender appointed auditor of the stocking loan;
the processing station being arranged to store details about all the stock of the dealer and the stocking loan such that the outstanding amount of the stocking loan can be automatically updated as the sale of any item against which the loan is secured is recorded by the dealer and wherein the outstanding amount of the loan can be determined by the appointed auditor.

49. A system according to claim 48, wherein the processing station is arranged to carry out independent valuations of the items in order to provide an independent calculation for the purposes of auditor stocking loan evaluation.

50. A system according to claim 48 or 49, wherein the processing station is arranged to record information regarding the stocking loan against an independent item register and to remove the information on repayment of the part of the stocking loan relating to that item.

51. A system according to any of claims 48 to 50, wherein the processing station is arranged to submit a request to a plurality of lenders on behalf of the dealer for a stocking loan for the dealer's intended stock of items.

52. A system according to any of claims 48 to 51, wherein the processing station is arranged to transfer the loan funds from the lender's account in to the dealer's account.

53. A system according to any of claims 48 to 51, wherein the processing station is arranged to transfer the proceeds from sales of items against which a loan has been secured from the dealer's account into the lender's account.
